(19) United States
(12) Patent Application Publication
(10) Pub. No.: US 2002/0049815 A1
(43) Pub. Date: Apr. 25, 2002

(54) System for monitoring and managing information and information transfers in a computer network

(76) Inventor: Kayshav Dattatri, San Jose, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(21) Appl. No.: 09/740,730

(22) Filed: Dec. 18, 2000

Related U.S. Application Data
(60) Provisional application No. 60/199,994, filed on Apr. 14, 2000.

(51) Int. Cl. G06F 15/16

(52) U.S. Cl. 709/206

(57) ABSTRACT

A monitoring and management system for the transfer of electronic messages, or other information, over a digital network such as the Internet. In one embodiment, a networked computer system transmits messages from a source to a destination and a central management site provides tracking and delivery guarantees. The management site monitors operation of the system and recovers statistical information regarding the delivery of the messages or the messages themselves when requested using an open XML API. The system includes a database associated with management site for counting the number of messages delivered during a selected time period for billing purposes. Aspects of the system provide for a secure transfer of messages, tracking, monitoring, archiving, automated responses, statistics gathering and other features. The system provides for a plurality of route point processors for routing messages independently of the internet service provider (ISPs) routers and a unique forking algorithm whereby duplicate messages are generated and transmitted along separate communication backbones. Messages are archived at an intermediate point in the transmission path. The archival system and method provides a distributed archive that stores messages to guarantee message delivery to the destination, assist in message recovery and retains statistical information regarding the routing and delivery of the messages for subsequent access.

### CLAIM OF PRIORITY

This application claims priority from co-pending U.S. Provisional Patent Application No. 60/199,994 filed Apr. 24, 2000 entitled SYSTEM FOR HANDLING INFORMATION AND INFORMATION TRANSFERS IN A COMPUTER NETWORK which is hereby incorporated by reference, as is set forth in full in this document, for all purposes.

### BACKGROUND OF THE INVENTION

This invention relates to the transfer of information over a distributed computer network. More particularly, this invention relates to a method and system for efficient and secure monitoring and management of commercial communication over the Internet.

In the recent past, the electronic exchange of business information required businesses to establish proprietary electronic document interchanges (EDI) with its trading partners. EDI enables businesses to exchange information regarding common business transactions such as providing catalog information, requesting price quotations from its suppliers, issuing purchase orders and tracking delivery of ordered products. The information is contained in structured documents and is used in a wide range of industries to improve the efficiency of business operation.

Due to the extensive amount of information that must be exchanged, EDI requires reliable transmission infrastructure and robust computer networking capabilities to enable the exchange the information. For this reason it is common practice to establish dedicated high speed communication links such as a leased T1 line between each trading partner. While such links are reliable and secure, they are also expensive to establish and maintain. Thus, while every business needs to establish EDI relationships with each of their trading partners to improve efficiencies, many small businesses have been unable to do so because of the cost. Indeed, the expense of establishing a T1 line can often run several thousands dollars per month take many months of effort to set up. However, many small businesses are unable to justify the expense of converting from exchanging paper documents using the mail or similar delivery systems. Many small to medium size businesses are typically unable to afford the cost associated with participating in EDI simply because the volume of transactions it has with its trading partners are insufficient to justify the expense. In other instances, business do not use EDI because the prior art EDI systems do not readily scale to handle large numbers of participants without investing substantial sums of money to connect all of the business' trading partners. Accordingly, the use of EDI to exchange business documents has have been limited to businesses that can justify the expense of maintaining a proprietary computer network between it and its trading partners. Clearly, what is needed is a reliable inexpensive system that enables business to participate in EDI regardless of the volume of business it has with its trading partners.

Further, many businesses have invested substantial sums of money to configure and maintain application programs that enable business to business electronic commerce. These application programs streamline operations relating to supply chain integration. Due to the inherent reliability of such networks, legacy B2B application programs are rarely capable of efficiently dealing with delayed delivery or loss of data in transit. Thus, while the Internet holds promise to lower the cost to participate in EDI, businesses have also been reluctant to port B2B applications to distributed networks because of the lack of control over the data once it leaves a company's proprietary network. This concern arises because data transmitted over the Internet may be lost or delayed in transit for an extended period of time. For example, studies have shown that between four and six percent of the transmissions over the Internet are lost at some point along the Internet transmission path. Many more messages can be delayed for an extended period of time if the information is routed to a web server that is over loaded or that is not operating for a period of time. This inherent lack of reliability creates potential problems for both the data originator and the recipient.

By way of example, if a manufacturer uses an Internet-based EDI system to place an order with a supplier and the order document is lost during transmission over the Internet, the supplier will not send a confirmation of the order. However the manufacturer will be unable to determine if the message is lost or merely delayed. Thus, the manufacturer and the supplier must work to manually cancel the original order (because if it were to show up at the supplier at a later time it could be treated as another order) and then issue a duplicate order. Unfortunately, this type of problem is inherent in the distributed nature of the Internet itself. Accordingly, when businesses attempt to port these legacy B2B application programs, to a distributed communication network such as the Internet, it is difficult to verify delivery of the information. This suggests that a mechanism is required to confirm both the transmission and the receipt of information transferred over the Internet. Unfortunately, many legacy B2B application programs designed for proprietary networks are not readily adaptable to respond to transmission related delays or information loss. For this reason both the sender and the recipient need to be able to track the delivery and verify the content of the information.

Even if the legacy B2B application programs are adapted for use with a distributed network environment, they are not well adapted to scaling from hundreds of trading partners to thousands. It is not uncommon for a business to generate hundreds of thousands of transactions in a single day. Thus, whatever system adapted by the business must be capable of scaling to handle millions of transactions on a daily basis. Accordingly, notwithstanding the advantages associated with the prior art EDI systems, a method and system that adapts B2B applications for transmission of valuable business information over the Internet in a secure and reliable manner is needed.

### SUMMARY OF THE INVENTION

The present invention provides a system and method allowing businesses to send electronic messages, or other information, to conduct business over a digital network such as the Internet. Aspects of the system provide for a secure transfer of messages, tracking, monitoring, archiving, automated responses, statistics gathering and other features. Software components are used to handle details of the system including message process, message format, message syntax message semantics, message handling, message interaction and component message interfaces. The system provides for a plurality of route point processors for routing messages independently of the Internet service provider (ISPs) routers.

The system uses a virtual private network to provide message delivery within predetermined amounts of time and can provide message latency that is improved over general Internet traffic. Customer-selected security levels can be specified for different types of traffic. Continuous and updated status of the system's network and customer messages is available via a website. Further, the present invention provides an efficient, low cost system for sending and receiving information over a distributed communication network that avoids the expense associated with proprietary electronic document interchange (EDI) networks. The novel system architecture readily adapts existing EDI networks and business to business application programs (B2B application programs) for use over the Internet.

The present invention employs a unique forking algorithm whereby duplicate messages are generated and transmitted along separate communication backbones. Using the separate backbones, the present invention is able to adapt to unexpectedly high traffic volumes on one of the communication backbones. As used herein, messages are formed by wrapping the information generated by B2B application programs in an extensible markup language (XML) wrapper that incorporates the XML protocol for routing and enhanced security. XML is a flexible syntax for describing messages so that trading partners may understand each other's data.

The present invention further employs a single point of control to ensure that information is not lost in transit and that it is delivered to the intended trading partner in a timely manner. Central to providing this control is a portal design that enables software components to be deployed to satisfy workload and adapt to environmental changes such as an increase in the number of users.

The portal is modeled on servlets communicating across HTTP with the extensible markup language XML. The servlets operate under the auspices of a web server and generate XML documents (messages) that characterize the user's request. The servlet posts to another servlet. This servlet responds to the XML-phrased request by performing the necessary work to satisfy the request and then generates an XML response document. The servlet receiving the XML response accesses the appropriate XSL template (i.e., a style sheet) and a server-side XML parser to translate the XML into HTML. The servlet responds to an originating browser via HTTP. The portal design passes messages around the network in XML document containers. Thus, when a user requests information, the portal wraps the request into an XML document and passes it to the source system using HTTP post. The source system unwraps the request and retrieves the data using whatever native methods that are required. Native methods may include, by way of example, a SQL select to fetch data from a database. Once the data is selected the source system wraps it in an XML file and passes it back to the portal. The portal merges the XML data into the XSL style sheet and passes it back to the user as HTML between various systems within the network.

The portal architecture is an integration mechanism between products and product families that blends with the operation and control strategy of the system network. In one preferred embodiment, the portal architecture is an n-tier application architecture that consists of three layers: the user services, the business services and the data services.

The user services consists of support for web browsers such as Netscape Navigator, commercially available from Netscape Corporation, now a subsidiary of America OnLine, Inc., and Internet Explorer available from Microsoft Corporation. User services further include XSL style sheets to translate XML documents into HTML. This enables separation of presentation logic from business logic. User services still further include XSL-based servlets that access both the XSL style sheets and the XML documents served from the business services layer.

The business services consist of Java objects that execute requests on behalf of the user. The Java objects implement the facade design pattern in shielding the user services from the various systems and applications that can satisfy the user requests. Business services also include Java objects that generate XML documents in the formulation of the requests and in generating the responses to the requests, if the data source does not already perform that translation. In this manner the business services tier communicates with the data sources via HTTP using XML.

The data services consist of Java objects that translate originating system data formats into instances of Java objects. In a typical Java application or system, this performs simple object-relational mapping or XML schema-to-object mapping.

The portal software enables system administrators to turn tracing on or off to debug operations that fail or that are operating too slowly. Tracing is a session-based function so one session may be traced while others execute at the same time. Error trapping mechanisms are further provided with an error manager class that all servlets on the portal share. The object detecting the error delegates to the error manager to capture the error. The error manager traps the error and adds it to the session error collection. At the appropriate time, the controller class raises the error and the error manager either redirects the user session to an error page or logs the entry as an error into the system log or both.

### BRIEF DESCRIPTION OF THE DRAWINGS

FIG. 1 illustrates the system hardware architecture and the interconnection of the main elements of the present invention.

FIG. 2 is a simplified illustration of the interconnection of the elements of the present invention.

FIG. 3 is another simplified illustration of the interconnection of the elements of the archival database of the present invention.

FIG. 4 illustrates partitioning of a user's partition in the archival database in accordance with the present invention.

FIG. 5 is a flow diagram illustrating processing logic of the present invention.

FIG. 6 illustrates tables used in tracking receipt of messages in accordance of the present invention.

FIG. 7 illustrates partitioning of the archival database of the present invention.

FIG. 8 illustrates the hierarchical design of the portal site of the present invention.

FIG. 9 illustrates one embodiment of a top level web page of the portal site of the present invention.

FIGS. 10A-10 illustrate a series of web dialog pages that enable a user to set up an account to access the features provided through the portal site of the present invention.

FIG. 11 illustrates a home web page that enables the user to navigate the portal site of the present invention.

FIGS. 12A-12F illustrate web page documents generated by the portal site to enable viewing historical activity with trading partners, tracking and viewing specific messages and viewing the overall worldwide status of a network in accordance with the present invention.

FIGS. 13A-13G illustrate web page documents generated by the portal site to enable viewing selected service level, usage of service and payment details in accordance with the present invention.

FIGS. 14A-14P illustrate web page documents that are accessed to configure network operations in accordance with the present invention.

FIGS. 15A-15D illustrate web page documents that are accessed when the user requires general help to use the system and features of the present inventions.

FIGS. 16A-16E illustrate web page documents that are accessed to monitor operation of the network topology of the present invention and respond to network related problems.

FIG. 17 illustrates the configuration of one embodiment of the portal of the present invention.

### DETAILED DESCRIPTION OF A PREFERRED EMBODIMENT

In the following description of a preferred embodiment, reference is made to the accompanying drawings, which form a part hereof, in which is shown by way of illustration specific embodiment in which the invention may be practiced. In the following description, numerous specific details are set forth in order to provide a complete understanding of the present invention. It will be apparent to one skilled in the art that the present invention may be practiced without the specific details. In the development of the actual implementation, numerous implementation-specific decisions must be made to achieve the design goals which will vary for each implementation. Accordingly, in order not to obscure the present invention, well-known structures and techniques are not shown or discussed in detail.

The present invention relates to a message delivery system directed to the efficient, reliable and secure delivery of information across a distributed network such as the Internet. More particularly, the present invention relates to a message delivery system for electronic document interchange (EDI) adapted for use with a distributed communication system and a distributed archival database. In one particular embodiment, the database archives in a manner that enables recovery if the message is initially undeliverable as well as statistical information regarding delivery. The archival database is geographically distributed with a fault tolerant architecture. Proactive monitoring and a fault tolerant design insure that access to the archival database is always available.

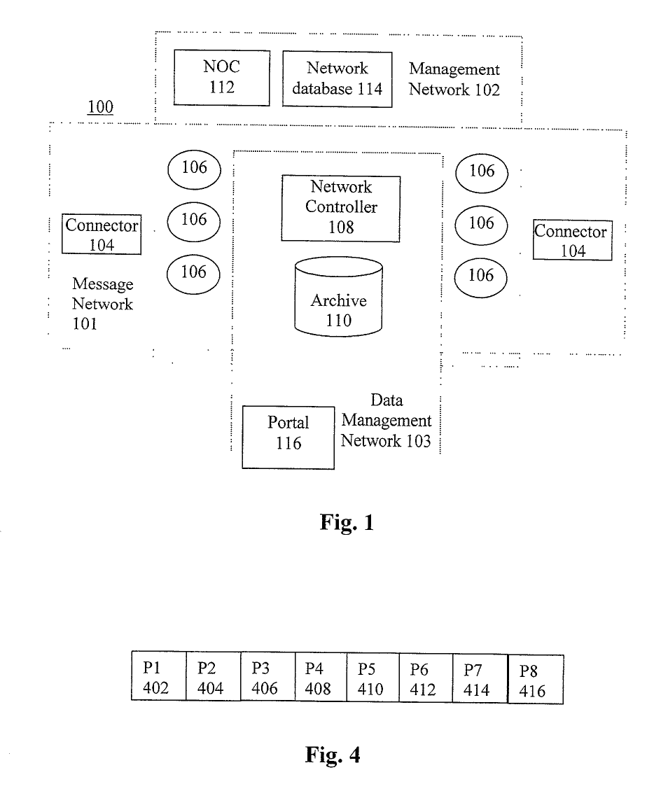

Referring now to FIG. 1, the topology of one preferred embodiment of network 100 is shown. In this embodiment, the network is partitioned into three virtual networks referred to as message delivery network 101, management network 102, and data management network 103. The message delivery network 101 employs connectors 104, route point processors 106, a network controller 108 and archival database 110 to move messages from the source to the destination.

The management network 102, which monitors and manages operational features of network components, comprises a network operations center (NOC) 112 and a network database 114. The dotted lines in FIG. 1 are used to show the logical configuration of the networks and how various components are associated with different networks depending on the particular function being performed. The overlap of the networks is illustrated with reference to management network 102 where NOC 112 dedicated to monitoring the physical status of the respective components and the communication backbone of message delivery network 101. When NOC is notified of a problem, alert messages are transmitted to network managers or other personnel responsible for maintaining the network system. The alert message is transmitted either by e-mail, fax, telephone, pager, or other communication means such that appropriate personnel and repair equipment are timely dispatched to correct the problem. NOC 112 employs commercially available network management tools, to remotely identify and correct the cause of the problem. Network controller 108 and NOC 112 utilize a shared network database 114 to exchange status information regarding the operational status of the network.

Data management network 103 provides a user having appropriate security access to query archival database 110 for data mining and monitoring performance parameters of message network 101. As with management network 102, data management network 103 encompasses portions of the message network 101 and more specifically, route point processors 106, network controller 108, and archival database 110. In order to fully understand and appreciate the advantages and features provided by data management network 103, the message delivery network 101 and management network 102 are first described to provide an understanding of the structure, topology and operation of the present invention. Using the preferred network topology of the present system, the present invention provides the features of data management network 103 that enable businesses to obtain greater control over the electronic transmission of their business documents.

Message delivery network 101 includes a plurality of connectors 104 through which B2B/EDI application programs (referred to hereafter as B2B application programs) or users gain access to the message delivery network. Although only two connectors 104 are illustrated in FIG. 1, it should be apparent to one skilled in the art that the numbers of connectors is not limited because the connectors are software components that may populate any end user or application server.

Each connector 104 provides the necessary interface between message delivery network 101 and the respective source and destination application or user. More specifically, connectors are the main workhorses of message delivery network 101. Each connector is responsible for encryption, compression, XML packaging, address resolution, duplicate message filtering, error recovery operations and passing messages upon receipt to the appropriate B2B application program or user.

Connectors 104 may include an adaptor module that provides an application program interface (API) that plugs into a third-party B2B application program. This adaptor may be a Java object specifically programmed to handle the transfer of data to and from application and to establish a connection through any intervening firewall. The integration of the connector with application or the specific API are considered implementation-specific and are not further discussed herein. The primary function of adaptor is to handle the translation of information between an application generator and standard HTTP protocol. The adaptor does not require any knowledge of the content of the payload other than the deliver address and delivery priority so the payload information may be encrypted for security.

Each connector 104 comprises a software module referred to as a routing processor which contains the logic necessary to interface to message network 101. The primary responsibility of routing processor is to establish connection with selected route point processors 106 in accordance with network configuration data obtained from network controller 108. The routing processor connector functions as an HTTP proxy interface for the application generator establishing contact with specified route point processors 106. In one preferred embodiment, routing processor is a Java object having the function that enables communication between the connector and the network controller 108.

Message delivery network 101 further includes a plurality of route point processors 106 and network controller 108 responsible for managing connections between connectors and route point processors. In operation, routing processor establishes a connection with at least two route point processors 106 using communication backbones specified by network controller 108. Routing processor then prepares two messages for transmission. One message is designated as the primary message. The other message is designated as the secondary message. Both messages are identical, except, however, each message will be sent along a different communication backbone to separate route point processors. In this manner, if one transmission network is slow due to high volume of traffic or is experiencing transmission delays or disconnection problems, the other message will be routed along a different communication backbone not experiencing such problems.

The primary task of network controller 108 is to load balance message traffic over the message delivery network 101 so that connectors are not assigned to route point processors experiencing high traffic volume. Load balancing seeks to minimize transit time for each message by identifying system bottlenecks and re-configuring network topology when necessary. Delivery latency is minimized when communication backbone has sufficient transmission bandwidth to handle the message volume. In comparison, transmission over the Internet is blind in that messages could get routed to an internet service provider (ISP) that is overwhelmed and unable to promptly forward on messages. When updating routing configuration, network controller 108 pushes information directly to the selected route point processor. Any information sent by network controller 108 to a connector is routed through a route point processor and passed on to the connector once a socket connection is established.

Both connectors and route point processors can access network controller 108 and pull information necessary, by way of example, to recover undelivered messages, track delivery status of messages, determine average transmission latency or determine the content of previously delivered message. Network controller maintains network database 114 which includes information relating to the real-time status and operation of network 100. It will be appreciates that when a problem is identified by NOC 112, a status update is reflected in database 1114. In response to status updates, network controller 108 may re-configure network configuration to minimize the impact of the problem on the operation of the network.

Route point processors 106 are Internet-based message engines capable of accepting multiple connections and handling multiple threads. Route point processors 106 act as a route point between connectors 104. Route point processors allow messages to be delivered to the selected destination along segments of a communication backbone selected by the network controller 108. In order to deliver messages, route point processors 106 retain messages until the specified connector establishes a socket connection which is a virtual connection between processes using Unix's standard I/O over network communication backbone. Using this connection, the route point processor delivers inbound messages to the connector.

Message network 101 further includes a redundant, fault-tolerant distributed archival database 110 that serves as a message repository. Physical components of archival database 110 such as disk drives and controllers are geographically distributed throughout the message network 101 and are coupled to the communication backbone through route point processors 106. In one preferred embodiment, archival database 110 comprises sets of independent databases that are partitioned and dedicated on a “per connector” basis. Archival database 110 is a write-mostly database, but is accessed in conjunction with message recovery algorithms initiated by a destination connector, reporting and data mining operations.

Since route point processors 106 retain messages until the destination connector establishes the socket connection, the present invention uses the route point processor 106 as archive points for messages transmitted between connectors. Specifically, when a message arrives at a route point processor 106, it is duplicated with the duplicate message redirected to archival database 110. This duplication and redirection process is performed transparently to either the source or destination connector. With the archival copy, delivery of the message to the destination connector becomes the responsibility of the route point processor even if the destination connector is down or otherwise not accepting messages. The combination of the route point processor and archival database 110 enables transport level acknowledgments to be used as the protocol between a source connector and the route point processor to establish proof of delivery.

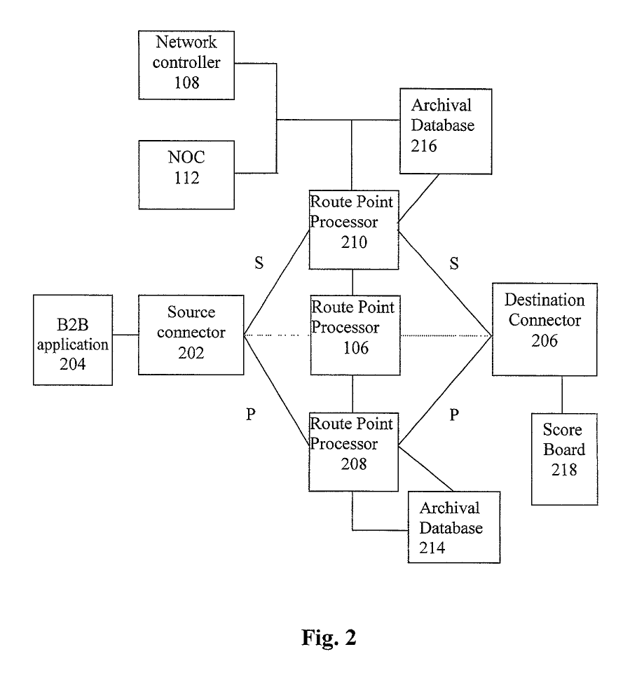

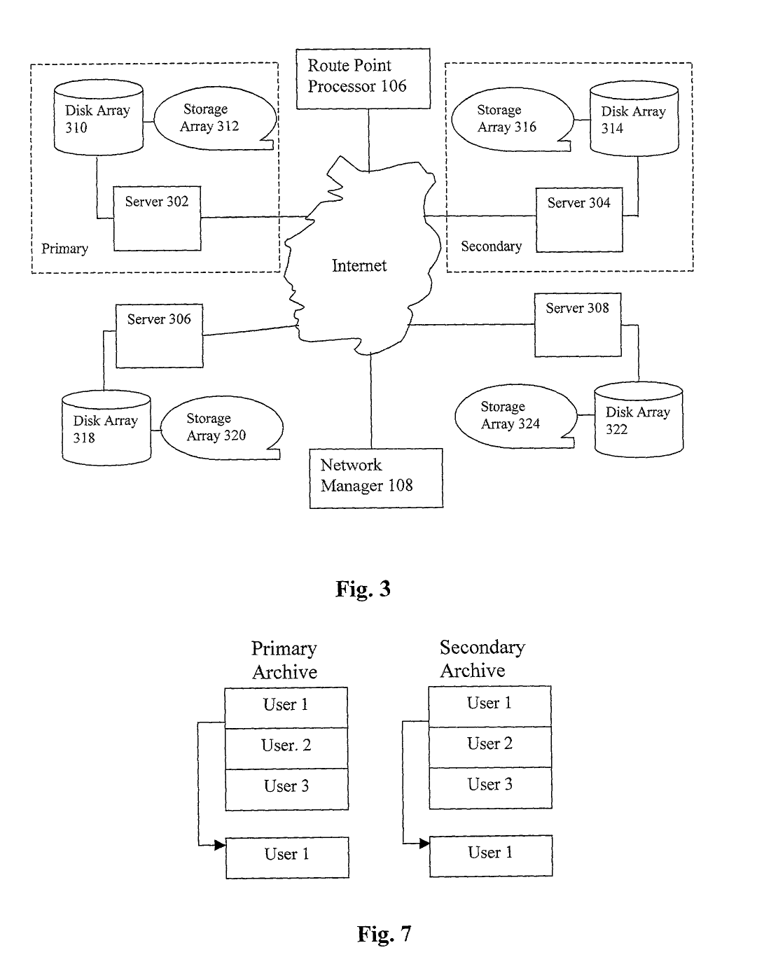

The operation of network 100 is described in conjunction with FIG. 2 which illustrates network 100 in the context of two trading partners. Source connector 202 is responsible for generating and delivering messages to the communication backbone. More specifically, once source connector 202 has generated the message, it establishes transmission paths along two separate communication backbones to primary and secondary route point processors. By way of example, source connector 202 establishes a first transmission path with route point processor 208 and a second transmission path to route point processor 210. Then, source connector 202 transmits the message twice using the two separate independent backbones. In this manner, each route point processors 208 and 210 receives the message. It will be appreciated that the present invention may be readily adapted so that more than two messages are transmitted if dictated by the specific requirements of a particular application. Source connector 202 retains a copy of the message until an acknowledgment of message receipt at the respective route point processors is received.

Each route point processor archives the message in an archival database associated with the source connector upon receipt. Since there are two messages in transit, two separate archived copies of the message will be retained. As a practical matter, one of the messages sent from the source connector to one of the route point processors will be designated as the primary message. This message will be stored in an archival database that is designated as primary archival database 214. The second message sent from the source connector to the other route point processor will be referred to as the secondary message. It is transmitted along a different communication backbone to a secondary route point processor where it is archived in a secondary archival database 216. It should be understood that the primary and secondary designations are arbitrary and assigned merely for convenience. In the event that one of the transmission path, route point processor and/or archive were to fail due to a physical or logical problem, any message may be readily acquired from the other archive along the other transmission path. The duplicate transmission of messages from source connector and the duplicate archival of messages provides a redundant fault tolerant system that ensures the delivery of the message to the destination even if there is a failure or delay in the delivery process. For this reason, once the message is archived, each route point processor transmits an acknowledgment to the source connector and assumes responsibility for delivery of the message. The source connector is then free to engage in other tasks.

Each route point processor attempts to transmit the message to destination connector 206, if possible. If the destination connector is not active, messages are retained in the archive until such time as the destination connector is again available. Upon receipt of the primary message at destination connector 206, a confirmation acknowledgment is sent to the primary route point processor. Another confirmation is sent to the secondary connector upon receipt of the secondary message. Each route point processor then writes the receipt confirmation to the respective archival database with additional delivery-related information indicating the time and date of the delivery. Further, each route point processor periodically transfers a summary record to network controller 108 specifying the number of messages received from the source connector and delivered to the destination connector.

At the destination, destination connector 206 checks scoreboard 216 to determine whether the message sequence number associated with the message has been previously recorded. If the message has not been received, the destination connector updates scoreboard 216 to indicate receipt of that specific message and the XML wrapper activates the appropriate B2B application program and the opaque information is provided thereto. If one of the messages has already been received, destination connector will not transmit the subsequently received (that is the second to arrive) message to the B2B application program or the user associated with the destination connector 206.

If destination connector is non-responding and neither route point processor can complete transmission, an error condition is encountered. Each route point processor maintains the message in the archival database until the destination connector is available. Further, both the primary and secondary route point processors will notify the network controller 108 indicating that a transmission path to the destination connector 206 can not be established. When destination connector 206 is again operational, it registers with network controller 108 during the re-boot/registration process. As part of the registration process associated with re-booting, destination connector will obtain information from network controller 108 regarding any messages that may have been missed during the non-operational time period. Network controller 108 transmits information regarding the source of the message, the time it was sent, and a sequential message number. This information is received by destination connector 206 and stored in the associated scoreboard 216. Subsequently, destination connector 206 establishes a connection with any available route point processor in the network system, for example, route point processor 106. Destination connector then uses information obtained from the network controller to request specific messages from the archival databases.

The route point processor receiving destination connector's request establishes a connection to either the indicated primary or the secondary archival database to recover the message. Once the message is recovered from the archival database, the route point processor transmits the message to the destination connector. Upon receipt of the recovered message, an acknowledgment is sent from the destination connector 206 to the route point processor indicating receipt of the information. For message tracking purposes, the acknowledgment provides the time and date that the message was delivered by the primary and secondary archival databases. Route point processor 106 is responsible for updating both archival databases. After sending the acknowledgment indicating receipt of the message, destination connector then verifies that the message has not previously been received by comparing the sequential message number to previously received message numbers.

With the distributed database archive of the present invention, messages sent between trading partners are archived in a manner that guarantees one hundred percent transmission of messages or, alternatively, prompt notification of the failure to deliver the message. Accordingly, the present invention avoids the problem associated with messages being lost or dropped when transmitted across the Internet. By eliminating the problems associated with interfacing legacy B2B application programs with public networks such as the Internet, the present invention provides the layer of logic and system components that adapts virtual private networks (VPNs) for use in EDI applications used by large numbers of trading partners. As is well understood in the art, VPNs may include the use of encryption in the lower protocol layers to provide a secure connection through an otherwise insecure network such as the Internet. VPNs are generally cheaper than real private networks using private lines but rely on having the same encryption system at both ends, a task well suited to being included in the connectors. This layer of encryption provides extra protection by encrypting the messages to prevent a listener from improperly obtaining information. Further, the present invention scales to an unlimited number of trading partners.

Referring again to FIG. 1, archival database 110 is central to providing many of the advantages associated with the present invention. In one preferred embodiment, archival database 110 is capable of storing approximately one million messages per day per trading partner. Advantageously, archival database 110 is scalable to meet the actual number of messages between a business and its trading partners so if the message volume were to increase, additional hardware components may be added to the network and the archival database seamlessly expanded.

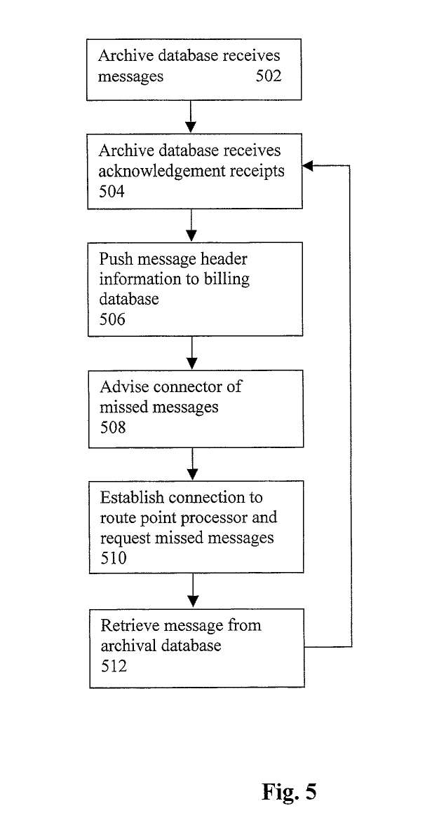

A portion of archival database 110 is illustrated in FIG. 3 as comprising web servers 302, 304, 306 and 308 each having a plurality of disk drives and back up storage devices such as tape drives or optical disk drives. As illustrated, web server 302 has disk drives 310 and backup devices 312 while web server 304 has disk drives 314 and backup devices 316. It will be understood that archival database 110 includes a plurality of web servers geographically distributed throughout the world to ensure that access to the archival database is not precluded by a local disaster or hardware failure. By way of example, if the primary archival database is located in San Jose, Calif., the secondary archival database for one specific connector would be located in a different city such as Nashville, Tenn. or Paris, France. Regardless of location, web servers 302-308 are coupled to the network controller and route point processors by a communication network, such as lease line or the Internet. The use of two companion archival databases dedicated to each connector guarantees timely delivery even if the destination connector is not available at the time the messages are delivered to the route point processor or even if one of the web server is being upgraded or is experiencing a hardware failure.

Network controller 108 is responsible for designating the web servers assigned to each connector. For example, if one user expects to send 100,000 messages per day, the network controller will designate two available web servers by sending the connector the IP address of each web servers as well as the listening port. This IP address and port information is included in the header of the message by the connector. When additional users sign on to use the system, network controller 108 acquires an estimate of the number of messages expected from each user. As a practical matter, contractual agreements generally are used to specify the maximum number of messages the user is authorized to send during a calendar day and this information is generally made available as part of the client profile retained in network database. This maximum number of messages is used to allocate sufficient space in the archival database. Thus, if the second and third users are each entitled to send 500,000, one of the users will be assigned to the archives associated with web servers 302 and 304 while the second user will be assigned to web servers 306 and 308. It is to be understood that the assignment is based on criteria employed by the network controller 108. It is to be understood that the criteria used by network controller 108 is a engineering decision and in the manner in which it assigns web servers to a particular connection is not important but rather that the assignments be updateable in real time. Network manager 108 may change the assignment at any time as dictated by high traffic, excessive latency, component failure or other factors as determined on a case by case basis.

Each web server 302-308 includes a computer server capable of handling multiple threads simultaneously and program logic executed by the computer server for performing the archive functions. Web servers archive messages in a relational database upon receipt from the route point connector. In one preferred embodiment, the database engine is the relational database management system Oracle 8i, available from Oracle Corporation of Redwood City, Calif.

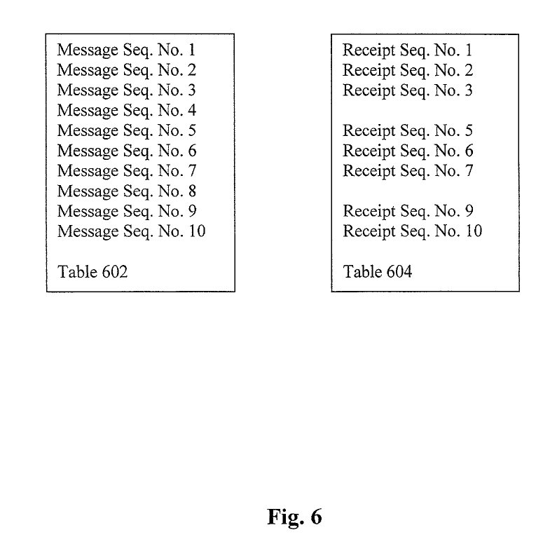

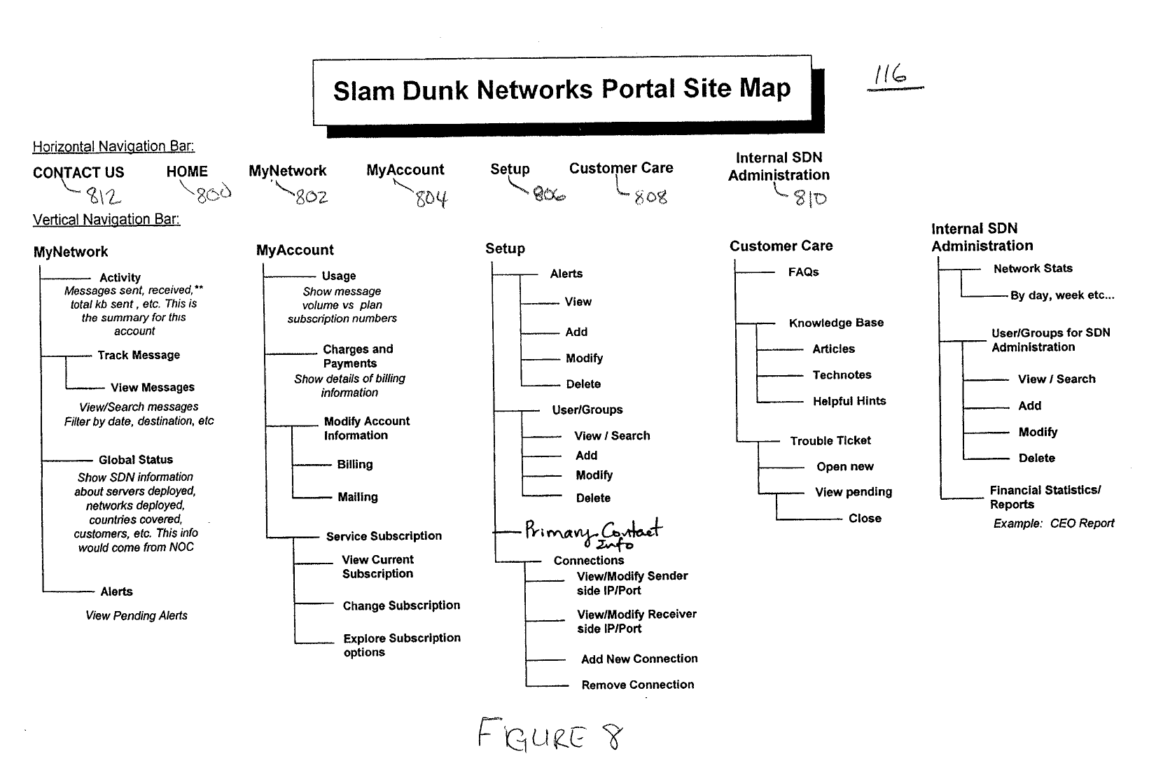

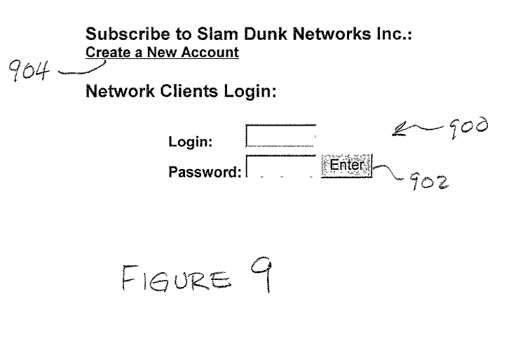

The disk drives are logically partitioned for each user. Thus, since each archival database can store up to a million messages on a daily basis, a first user that has contracted to send 100,000 messages per day would have a partition capable of storing up to 100,000 messages. If the user were to increase the number of daily messages, the partition size could be correspondingly increased. Within each user partition, additional logical partitions segregate messages sent on a daily basis. In one preferred embodiment, each user partition is further partitioned into eight (8) additional partitions 402-416 as shown in FIG. 4. When the user first sends messages, messages and delivery receipts received from the destination connector are stored in partition 402. Messages and delivery receipts received on the next subsequent period are stored in the second partition 404 and so on until seven partitions have been filled. In the preferred embodiment, each period is a calendar day. During the eighth period (which, in the preferred embodiment, is the start of the next cycle), messages and receipts are stored in the eighth partition 416 and the contents of partitions 402-414 are moved to off-line storage. The partitions minimize the number of time an archive database needs to be moved to back up storage devices. Since these partitions form a circular buffer, the second period of the second cycle will be stored in partition 402 and so on.

The program logic on the web server performs the critical task of matching delivery receipts from the destination connector with the messages. This matching process is illustrated with reference to FIGS. 5 and 6. In typical operation, a message is received at the archival database from the source connector as indicated step 502. At step 504, receipts are received from destination connector. The program logic matches the receipt with the message and notifies the network controller that the message has been delivered. Since the business model associated with the present invention contemplates that users are billed only upon receipt, notification is critical to the billing process. In one preferred embodiment, the web server pushes the message header information to a database associated with network controller as indicated at step 506. More specifically, a billing database is associated with network controller 108 that retains a sequentially ordered list of messages sent through the source connector to each of its trading partners. This database contains at least three months of billing information, that is, the message sequence number or other identifying information and the receipt information. At the end of each day, the tracking information is pushed from each of the archival databases to the billing database.

When messages are not deliverable immediately upon receipt at the route point processor and, when the current partition closes, no additional writes are allowed to the partition. Thus, if a message was received at time 23:59:59, the receipt will likely be recorded in the next subsequent partition. This means that an undelivered message remains in the previous partition. Similar problems arise if a message is undeliverable for a period of time in that the receipt and the message will reside in different partitions. To track deliver of messages over time, program logic maintains a first table 602 listing the Sequence number of messages received and a second table 604 listing receipts received such as is illustrated in FIG. 6. Table 602 maintains the message sequence numbers in an ordered flat file sequentially. When a receipt is received, it is matched to the corresponding message sequence number and the message's header information is pushed to the network controller. When either the primary or the secondary message is received at the destination, a receipt is sent to both the primary and the secondary route point processor. Thus, it is possible that a receipt will arrive prior to the arrival of the corresponding message at the archive. This situation could occur if a communication backbone were to experience high traffic volume or if there is a hardware failure at the route point connector. Accordingly, table 602 will also maintain a list of receipts received but not yet matched with a corresponding message.

A similar problem arises in that an archival database does not receive a message from its route point processor. Accordingly, the archival databases need to be resynchronized from time to time. When NOC 112 identifies a problem with a route point processor, the web server is notified. The web server then establishes a communication link with the companion database and transfers any missing messages. The processing logic executed by each web server includes a Java servlet to provide this function.

Referring again to FIG. 5, when a receipt for a message is not present in table 604, the network controller 108 is notified. Subsequently, when the destination connector is again receiving messages, the network controller will advise it of any missed messages as indicated at step 508. Network controller 108 determines which messages have not yet been delivered querying tables 602 and 604 to determine if a message has been received (table 602) but not yet matched with a receipt (table 604). Conceptually, table 604 filters the content of table 602 allowing only those message sequence numbers that correspond to un-sent messages to pass to the destination connector.

Upon receipt of the list of missed messages, destination connector issues a request to a route point processor for missed messages as indicated at step 510. Using the sequence number, the program logic at the route point server locates the web server, designates the archival database in which the message is stored and requests that the message be sent to the destination as indicated at step 512. When the delivery receipt is received, the receipt is combined with the message header and the network manager is notified as indicated at step 514.

On a weekly basis, the user's partitions are moved to an off-line storage device such as a tape drive. In the event that a particular message has not yet been sent, it is treated as a special case. Specifically, program logic searches for all undelivered messages and creates a copy in a reserved area as indicated at step 516. When the seven partitions are moved to the backup storage medium, the copy in the reserved area can be accessed in the event the destination controller were to request missed messages. However, the message could of course be always be recovered from the off-line storage device.

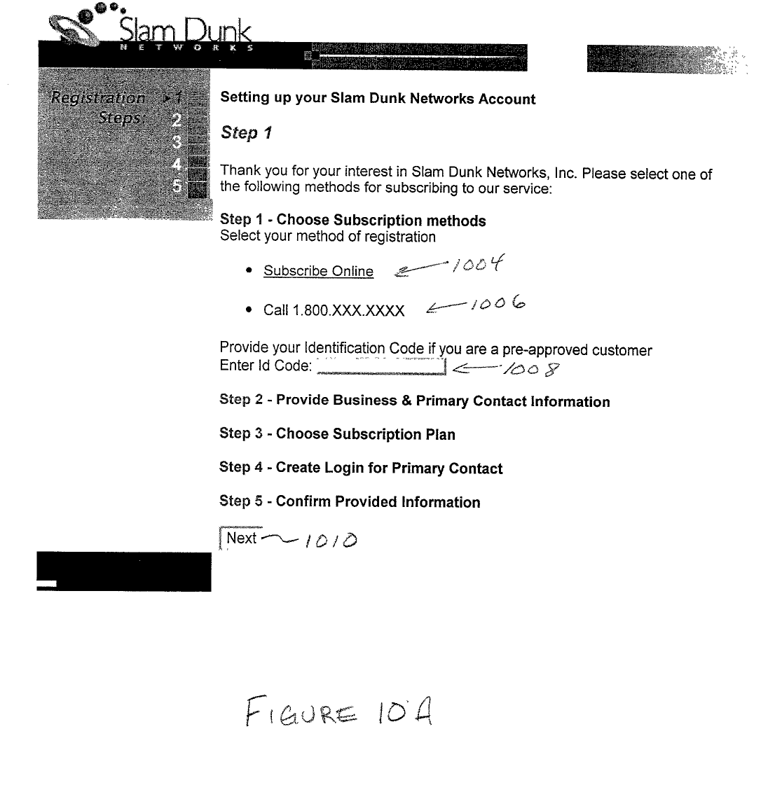

Referring now to FIG. 7, the partitioned architecture of the present invention provides additional advantages not present with prior art EDI systems. Specifically, each user partition may be expanded to meet message traffic without disturbing the archival databases associated with other users. When several users, by way of example user 1, user 2 and user 3, share primary and secondary archival databases that are operating at maximum capacity none of the users can expand unless space is taken from other users and assigned to the user requiring added space. Instead, when message volume expands, the present invention assigns the user with the increased message volume to another archival database without disturbing the shared archive. When a message is received from the high volume user, the route point processor uses a round robin strategy to populate the archives. Advantageously, additional archives are readily added to the network system assigned to a particular source connector. Network controller 108 monitors archive usage and assignment to maximize efficiencies. This scheme minimizes the overhead associated with recovering messages from the archives because, while a user is assigned to specific archives, network controller need only search a limited number of the web servers populating the system, when attempting to locate a message. Further, since there is no need to move the low volume user to another archive, system bandwidth is not utilized reorganizing the various archives when one user increases their daily message volume.

Another advantage of the present invention is the ability to data-mine the archive. For example, the user at the source can determine the most efficient communication backbone, transmission latency, the number of messages sent to each of its trading partners by querying the billing database. Yet another advantage provided by the archives arises from the authenticating nature of the archive. Specifically, the archive is maintained off-site from any user by a third party entity separate from either the sender or the recipient. In the event of a dispute where one party denies that the message was delivered, the archives may be queried to determine the time and date of delivery, the route the message took to reach the destination and the content of the message. Alternatively, the archive can be accessed to acquire the message either from one of the partitions or from the backup storage device. Since security is of concern, access to the archive is typically limited to the user associated with the source. Thus, the recipient will not be able to access any message other than those messages directed to the recipient.

Yet another advantage of the partitioned archive is that different versions of the program logic may be executed at each web server. Further, the program logic at each web server may be upgraded in sequentially since there is no requirement that the companion archives associated with a user be running the same version of the programming logic. Further still, during the time that an archive is off-line and new software is being installed, the network controller 108 or another partition may be used as a temporary archive caching messages until such time as the upgrade is complete. When an upgrade is complete the archive is re-synced with the missed messages archived by network controller. Accordingly, there is no limitation as to when an upgrade may occur.

The present invention further employs a single point of control to ensure that information is not lost in transit and that it is delivered to the intended trading partner in a timely manner. Central to providing control is a portal design that enables software components to be deployed to satisfy workload and adapt to environmental changes such as an increase in the number of users.

The portal is modeled on servlets communicating across HTTP with the extensible markup language XML. The servlets operate under the auspices of a web server and generate XML documents (messages) that characterize the user's request. The servlet posts to another servlet. This servlet responds to the XML-phrased request by performing the necessary work to satisfy the request and then generates an XML response document. The servlet receiving the XML response accesses the appropriate XSL template (i.e., a style sheet) and a server-side XML parser to translate the XML into HTML. The servlet responds to an originating browser via HTTP. The portal design passes messages around the network in XML document containers. Thus, when a user requests information, the portal wraps the request into an XML document and passes it to the source system using HTTP post. The source system unwraps the request and retrieves the data using whatever native methods that are required. Native methods may include, by way of example, a SQL select to fetch data from a database. Once the data is selected the source system wraps it in an XML file and passes it back to the portal. The portal merges the XML data into the XSL style sheet and passes it back to the user as HTML between various systems within the network.

The portal architecture is an integration mechanism between products and product families that blends with the operation and control strategy of the system network. In one preferred embodiment, the portal architecture is an n-tier application architecture that consists of three layers: the user services, the business services and the data services.

The user services consists of support for web browsers such as Netscape Navigator, commercially available from Netscape Corporation, now a subsidiary of America OnLine, Inc. and Internet Explorer available from Microsoft Corporation. User services further include XSL style sheets to translate XML documents into HTML. This enables separation of presentation logic from business logic. User services further still include XSL-based servlets that access both the XSL style sheets and the XML documents served from the business services layer.

The business services consist of Java objects that execute requests on behalf of the user. The Java objects implement the facade design pattern in shielding the user services from the various systems and applications that can satisfy the user requests. In one preferred embodiment, the business services incorporates system such as Infranet available from Portal Software, OpenVIew available from Intel, Corp., and Slam Dunk Control (SDC). Business services also includes Java objects that generate XML documents in the formulation of the requests and in generating the responses to the requests, if the data source does not already perform that translation. In this manner the business services tier communicates with the data sources via HTTP using XML.

The data services consists of Java and C++ objects that translate originating system data formats into instances of Java objects. In a typical Java application or system, this performs simple object-relational mapping or XML schema-to-object mapping.

The portal software enables system administrators to turn tracing on or off to debug operations that fail or that are operating too slowly. Tracing is a session-based function so one session may be traced while others execute at the same time. Error trapping mechanisms are further provided with an error manager class that all servlets on the portal share. The object detecting the error delegates to the error manager to capture the error. The error manager traps the error and adds it to the session error collection. At the appropriate time, the controller class raises the error and the error manager either redirects the user session to an error page or logs the entry as an error into the system log or both.

Refer again to FIG. 1 where portal 116 is shown as part of the data management network 103. Portal 116 enables end-users or application programs to access the data stored in archival database 110 over the Internet. Through portal 116, the present invention provides accounting, configuration, and performance information, as well as other value-added services accessed through the API defined by portal 116. Portal access provides an opportunity for off-line analysis and enables the user to regenerate or to define alternative databases conveying various levels of information and functionality.

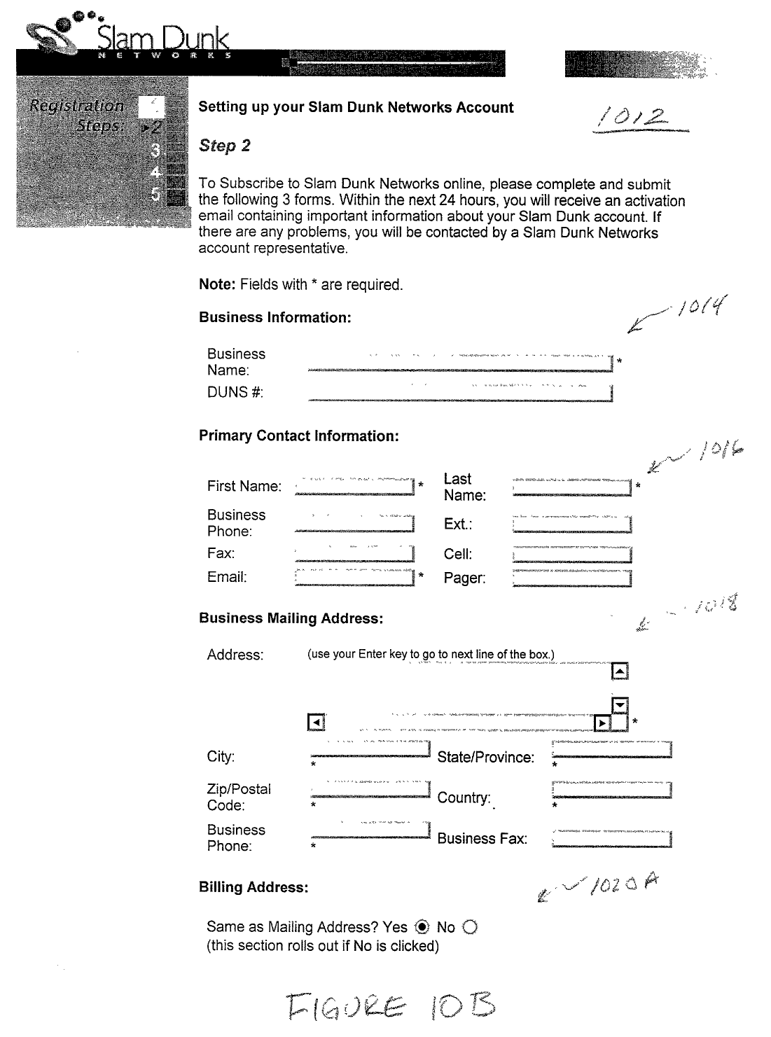

Portal 116 is described in conjunction with FIGS. 8-16. In one preferred embodiment, portal 116 is a collection of information stored in web documents organized in a hierarchical document tree structure. The web documents are stored on at least one web server computer system (not shown) coupled to the Internet and maintained by Slam Dunk Networks, Inc. of Redwood City, Calif., the assignee of the present invention. Using commercially available server software, the server computer system waits for requests from clients and then delivers the requested web page to the user. In many instances, the user's request activates a script that performs the requested function and returns the information to the user in an HTML document form for display on a browser.

The hierarchical design of the portal site is shown in FIG. 8. The hierarchical organization permits efficient navigation so that the user can rapidly access the desired function or feature. Specifically, portal 116 includes the following branches as represented by software buttons: Home 800; MyNetwork 802; MyAccount 804; Setup 806; Customer Care 808; and Internal SDN Administration 810. The user may jump from one branch to another by selecting the corresponding display button using a pointing device or other user interface device such as the keyboard. The display buttons 800 through 812 are shown at the top of the browser display on the user's computer system as a horizontal navigation bar.

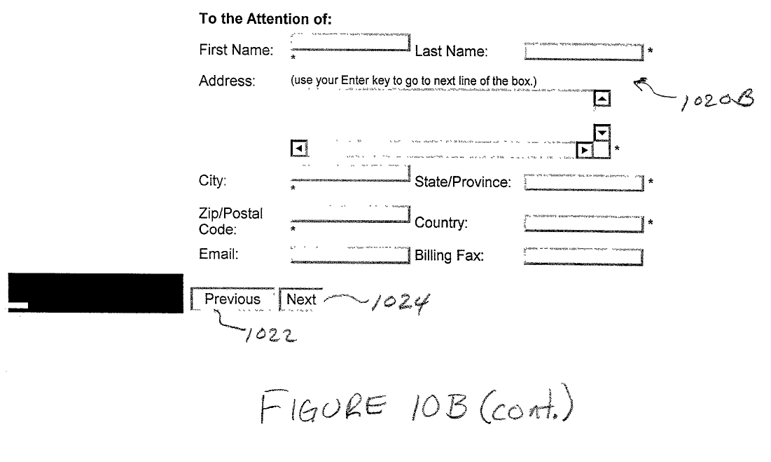

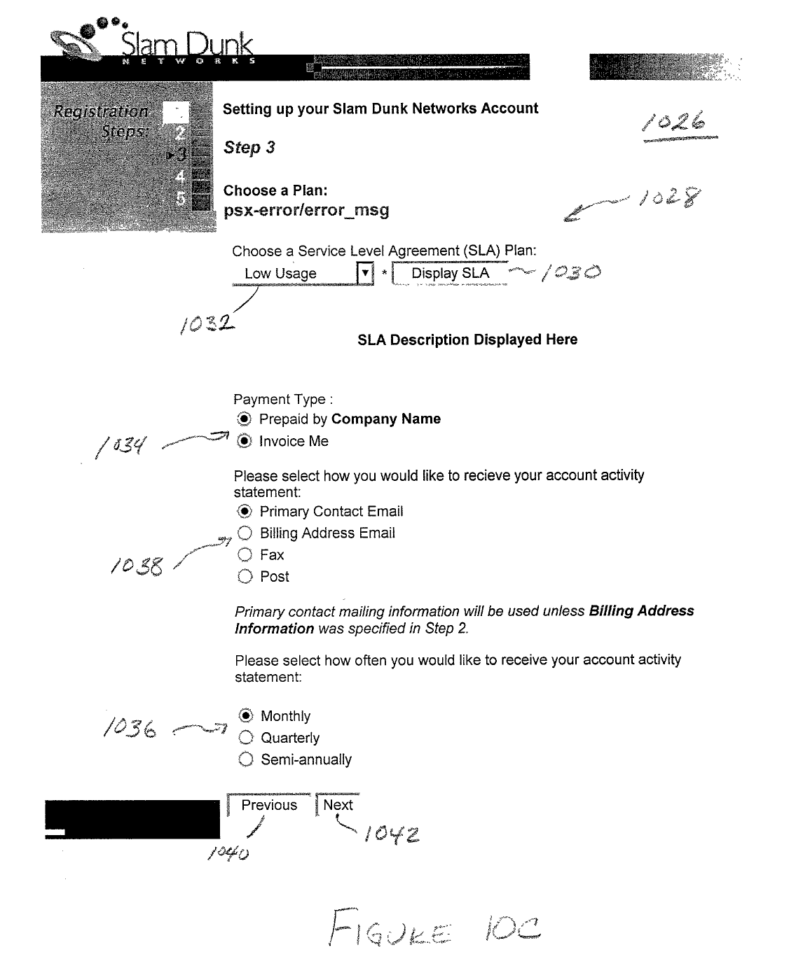

In order to access the horizontal navigation bar, the user must first access the top level web page of portal 116. The top level web page resides at a universal resource locator (URL) that is available via the Internet. FIG. 9 illustrates one embodiment of a top level web page associated with portal 116. This page may be located and accessed by any search engine such as, by way of example, Yahoo.com or by using the bookmark feature of the Internet browser. This page is a web form that includes spaces for user input. Once at the top level web page, the user may enter their login and password information at the dialog box as indicated at 900. Pressing the enter button 902 initiates the log-in process to authenticate the user. Web forms and the user authentication process are well known and are not further discussed. Once the user is authenticated, access to the portal site as illustrated in FIG. 8 is provided.

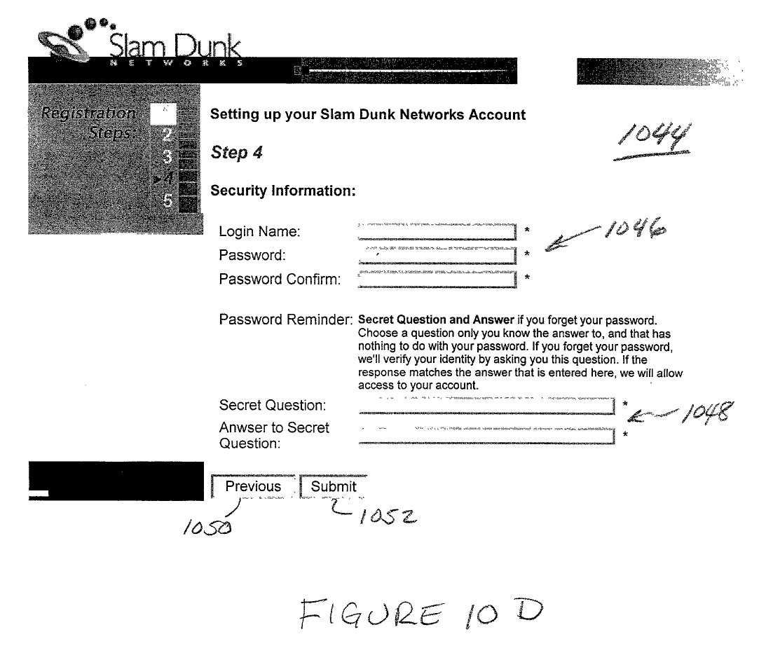

If the user is a potential client who does not have an existing account, the user is provided the opportunity to establish the account by accessing the hyperlink 904. Selecting hyperlink 904 opens a series of web dialog pages which are shown in FIGS. 10A-10E. The process to set up a Slam Dunk Networks account requires the user to enter user-specific information. Accordingly, the web document of FIG. 10A is as a web form designed to acquire the necessary information to establish an account for a user. In most instances, the user will be an authorized representative of a business entity. As shown in FIG. 10A, web page 1002 presents the user the option to subscribe on-line 1004 or to call a telephone number 1006 and establish the account using a human operator. Once the user selects to on-line subscription 1004, the user may provide a pre-approved customer number at 1008 in which case some of the required information may already be stored on the web server.

When the user selects the “Next” button 1010, the web server displays web page 1012 shown in FIG. 10B. Web page 1012 collects the business information required to identify the user and set up billing information. Specifically, the business name is entered at fields 1014, contact information is entered at fields 1016, business mailing address at fields 1018 and the billing address at fields 1020A and 1020B. Once the required information is entered, the user is provided the option of selecting the previous web page by selecting the “Previous” button 1022 or continuing on with the registration process by selecting the “Next” button 1024.

When Next button 1024 is selected, the information is transferred to the web server computer system and the next web page, form 1026, is displayed as shown in FIG. 10C. Form 1026 enables the user to select the service level agreement (SLA) plan. By selecting the SLA button 1030 or the drop down menu 1032, the user may select an available service level. These levels are usually a tiered pricing plan based on the projected volume of messages the business estimate they will be sending on a monthly, quarterly or semi-annual basis. In general users may select from a low usage plan, a corporate plan or a strategic plan. The low usage plan is geared to small business entities who do not, on average, experience heavy EDI traffic. This plan, in one embodiment, provides for 50,000 messages on an annual basis. The corporate plan provides for 1,250,000 messages on an annual basis. This plan is directed to those entities that are actively participating in EDI. With either plan, additional blocks of messages can be added seamlessly by adjusting the archive space allocated to each customer in the manner described in conjunction with FIG. 7. The strategic plan provides businesses, having a substantial number of trading partners or that operates a B2B marketplace or exchange, the ability to meet high levels of message traffic. In one embodiment, this plan provides capacity for 250,000,000 although one skilled in the art will appreciate in view of the above described system and method that the present invention may be readily adapted to support additional plans or refinements to these plans.

The user may also specify how the company will be billed by selecting a toggle button as indicated at 1034 as well as the frequency of billing as indicated at 1036. Selecting the desired toggle button at 1038 determines how the user will receive their account activity statement. Once the required information is entered, the user is provided the option of selecting the previous web page by selecting the “Previous” button 1040 or continuing on with the registration process by selecting the “Next” button 1042.

Selecting the Next button 1042 transfers the information obtained by form 1026 to the web server computer system and presents the security information form 1044 shown in FIG. 10D. Security information enables the user to select their login name and password as indicated at 1046. To enable the user to remember their password the form also enable the user to type in a secret question and answer as indicated at step 1048. Once the required information is entered, the user is provided the option of selecting the previous web page by selecting the “Previous” button 1050 or continuing on with the registration process by selecting the “Next” button 1052.

Selecting the Next button 1052 transfers the information obtained by form 1044 to the web server computer system and presents the client profile form 1054 that represents the client specific information entered by the user as shown in FIG. 10E. This information is retained in the billing database 114 associated with the network controller 108 of FIG. 1. Once the user reviews the displayed page, the user is provided the option of selecting the previous web page to correct any information by selecting the “Previous” button 1056 or continuing on with the registration process by selecting the “Create Account” button 1058. In response to selecting button 1058, the user's account is created and subsequent access provided through the top level web page web as illustrated in FIG. 9.

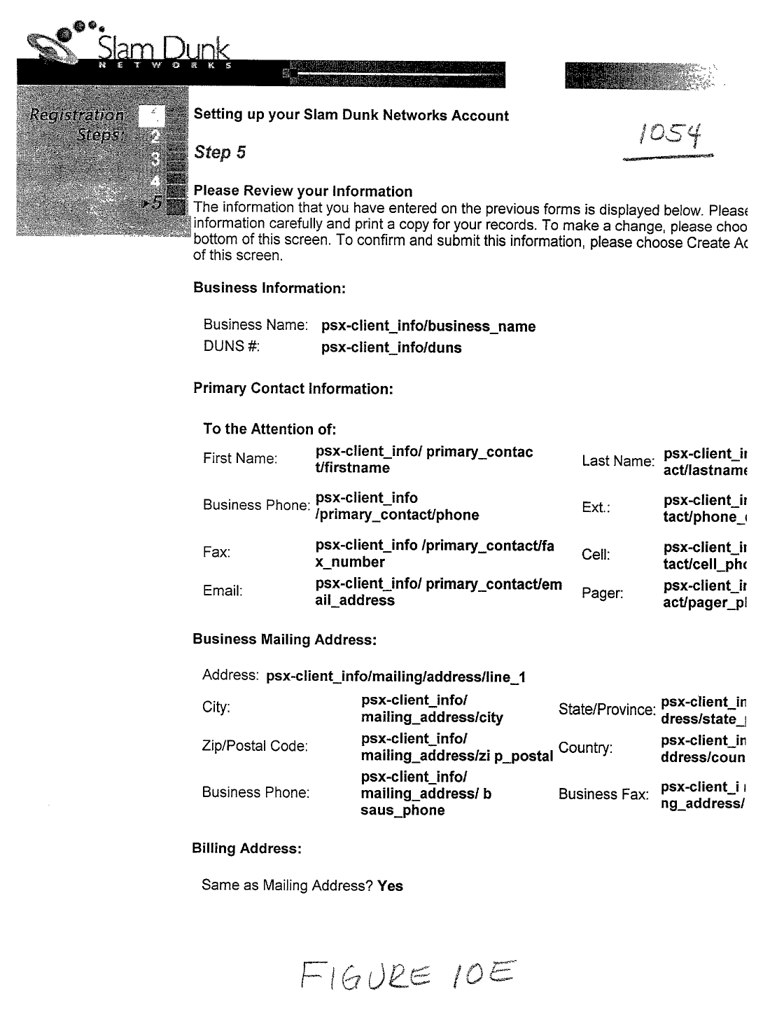

Once the user has an account, the user returns to the top level web page of FIG. 9 to access the features of the present system provided by portal 116. When the user authentication process is complete, the web server computer system displays the home web page shown in FIG. 11. The home web page 1100 provides a horizontal navigation bar 1102 and a vertical navigation bar 1104. The buttons displayed on navigation bar 1102 enable the user to jump to the top of a branch in the manner described above. The vertical navigation bar 1104 enables the user to drill down and access identified functions. Functions illustrated, by way of example, are “Logout” for when the user wishes to terminate the session, “Site Help” page, which displays an overview of the site and answers to frequently asked questions, and a “Contact Us” page that provides email, telephone and postal address. Home page 1100 also includes a graphical display of the worldwide status 1106 of network 100 (FIG. 1). In one embodiment, each route point processor and database web server site distributed geographically throughout the world is shown as a point of light on the world map. The home page further includes a graphical representation of the number of messages that have been sent over selected intervals of time. As illustrated, meter 1108 displays the number of messages that have been sent over the most recent two hour time period on a minute by minute basis. Meter 1110 displays the number of messages that have been sent during the past seven day period. The information for meters 1108 and 1110 is obtained from billing database 114 (FIG. 1). If the network is experiencing problems as identified by NOC 112, the alerts are shown in the alert display 1112. Alert display 1112 shows the date, time and description of the alert in a tabular format. Thus, when the user logs into the home page they are immediately presented the status of the worldwide network.

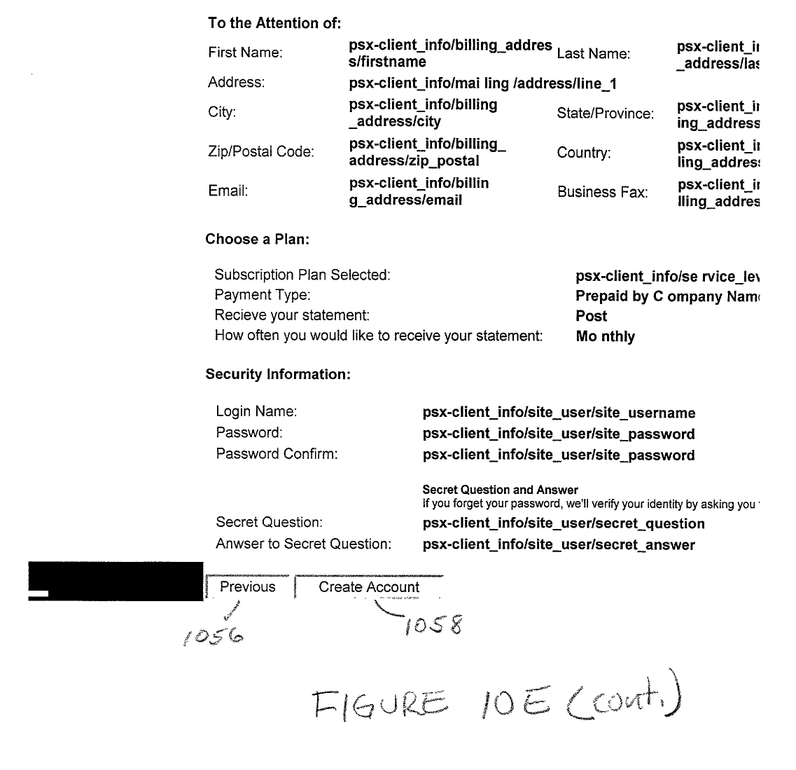

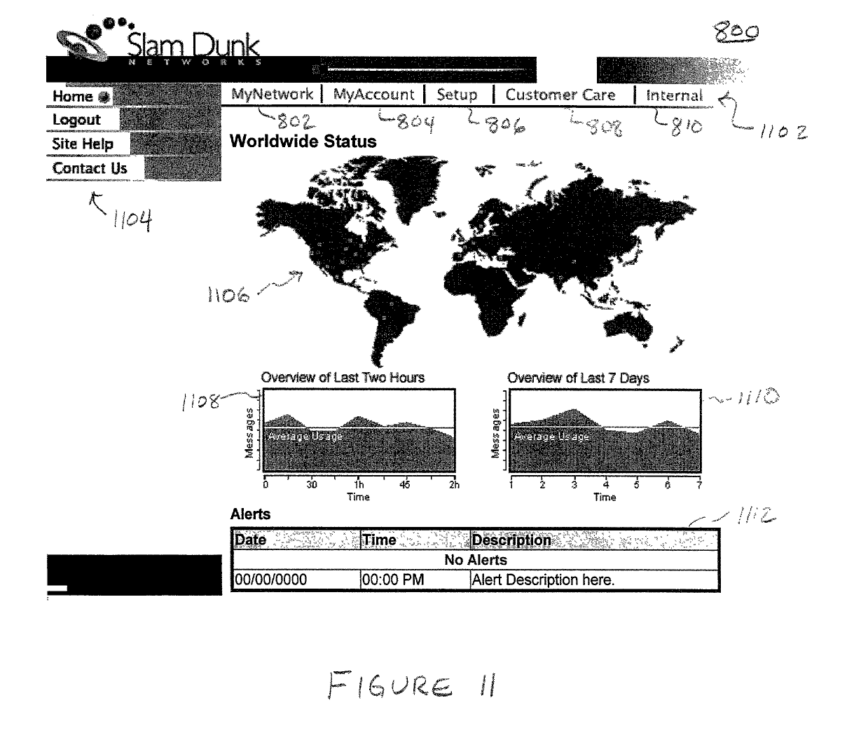

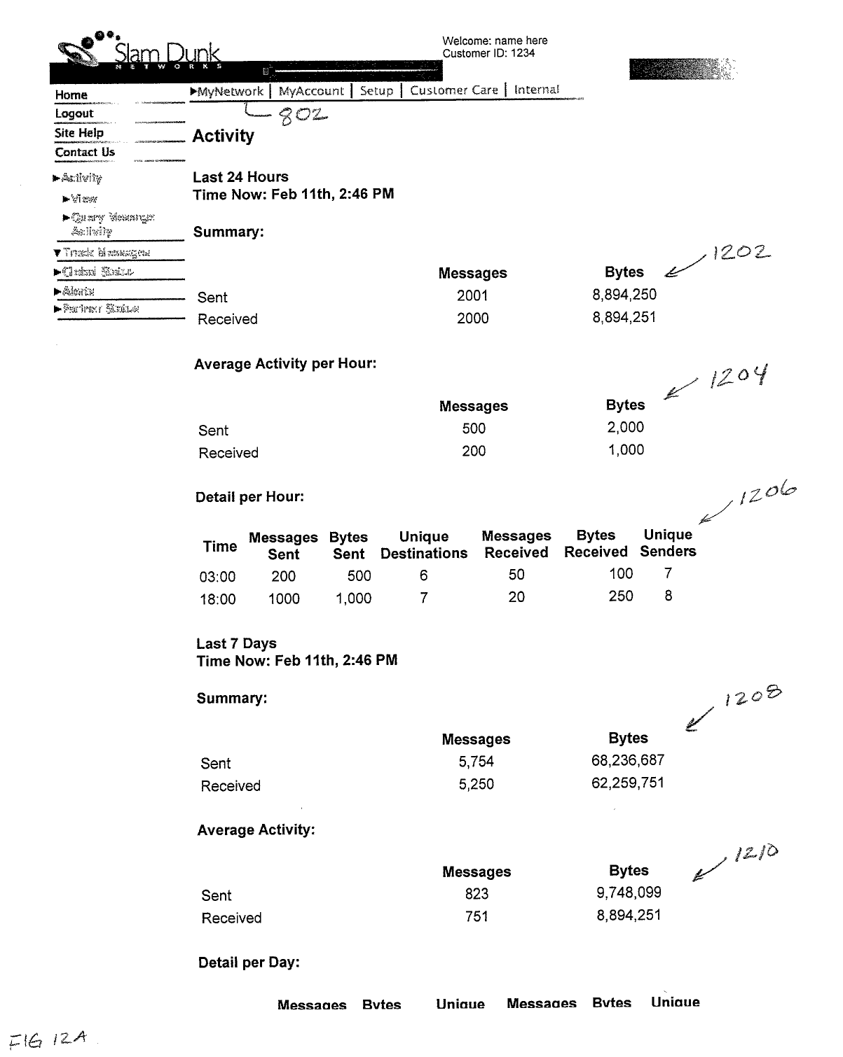

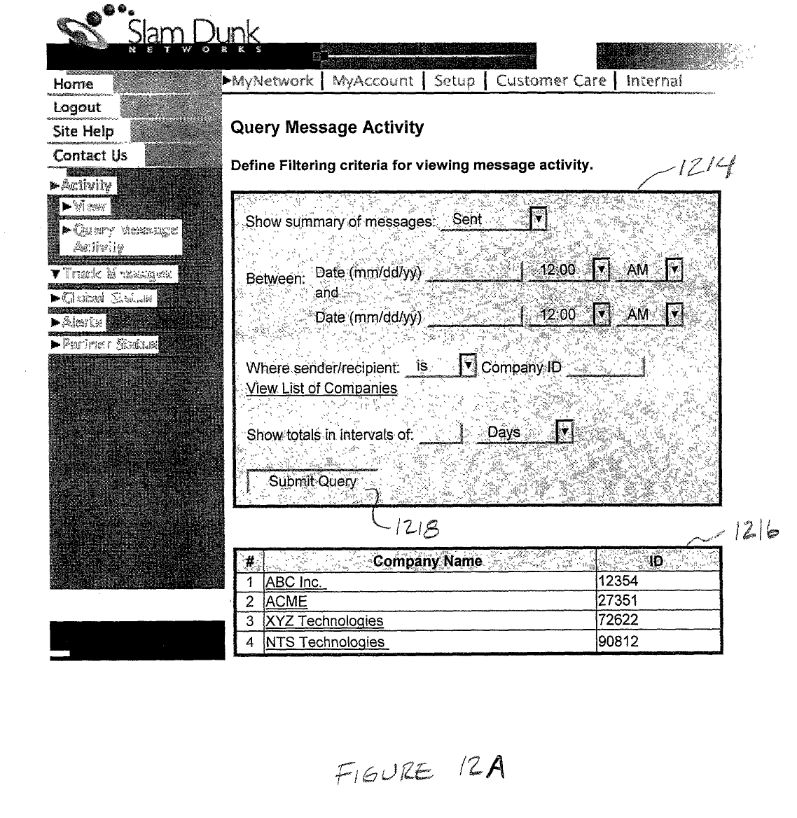

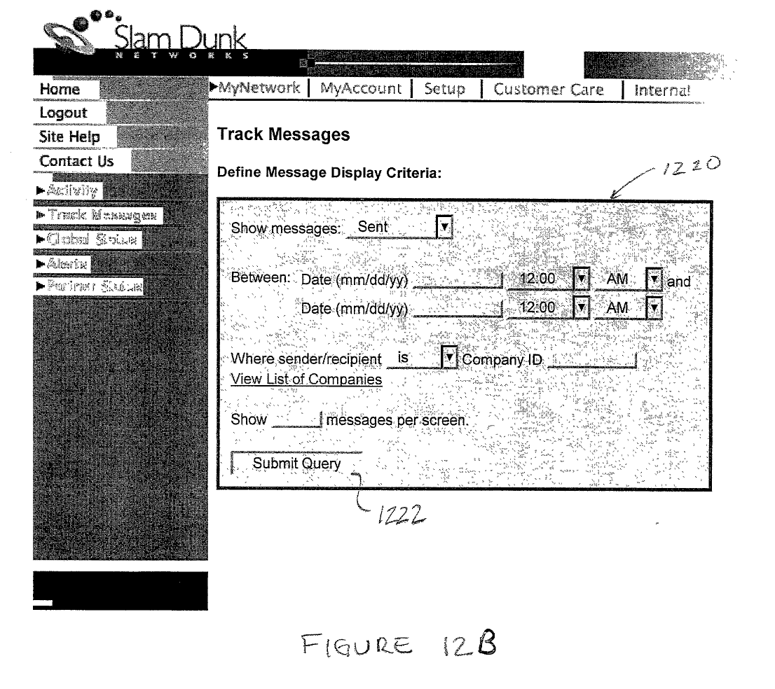

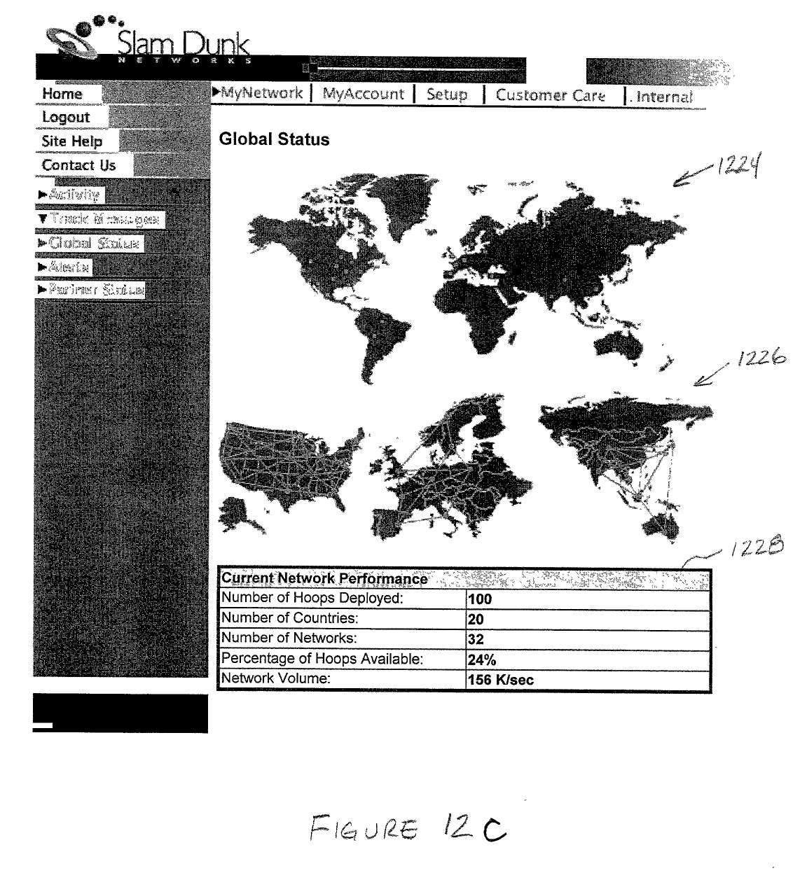

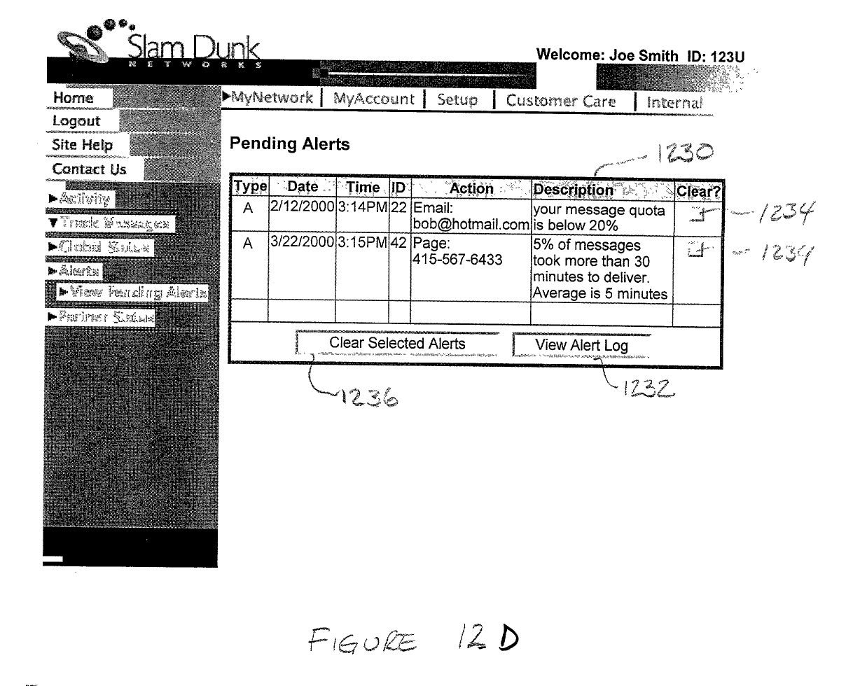

FIG. 12A illustrates a web page document that enables the user to selectively query database 114 by defining a filtering criteria. The filter criteria is specified at 1214 and enables the user to select from between messages sent or received during a specified period of time. The user may further specify the sender or recipient. If the user does not recall the company ID for a specific recipient, the user may select a link that creates a pop-up display 1216 that lists the trading partners. Selecting the “Submit” button 1218 send the query to the web server computer system where it is processed and a web page document of responsive messages are returned.

FIG. 12B illustrates a similar web page document that enables the user to track messages. Once the user has obtained the list of responsive documents from the query, the user may select the criteria as indicated at 1220 for the messages to be tracked. The appropriate time period and trading partner are selected and the Submit button 1222 is selected to request the message tracking information. The billing database is then accessed to provide the header information describing the time the message was sent to the route point processor and the time the message was received at the destination.

FIG. 12C illustrates a web page document that shows the global status of network 100. The graphical illustration 1224 is identical to the worldwide status 1106 of network 100 shown in FIG. 9. In addition, a graphical illustration 1226 of the communication backbone is also shown. If there is any disruptions to the network it is shown as a highlighted color. Listing 1228 provides a detailed overview of network topology and operational status.

FIG. 12D illustrates a pending alert web page document that is lists alerts that have registered with either the network controller 108 or NOC 112 (FIG. 1). These alerts as shown at 1230 are presented on this document primarily for administrative purposes because the alert will generally be broadcast to the appropriate technician to resolve. As illustrated in the “Action” column, the alert may be broadcast in a variety of selected manners. By selecting the “View Alert Log” button, 1232, the user may jump to an Alert Log web page document as illustrated in FIG. 12E which shows the current status of each alert. When an alert is resolved, a corresponding toggle button 1234 is selected and the “Clear Selected Alerts” button 1236 is selected to change the status of the alert from pending to cleared.

Referring now to FIG. 12F, the user is able to monitor the activity level of each trading partner. Specifically, a Partner Watch List is illustrated at 1238 that discloses whether any outstanding (i.e., undelivered) message are present. Undelivered messages show up on the Alert Log (FIG. 12D) after a specified period of time.

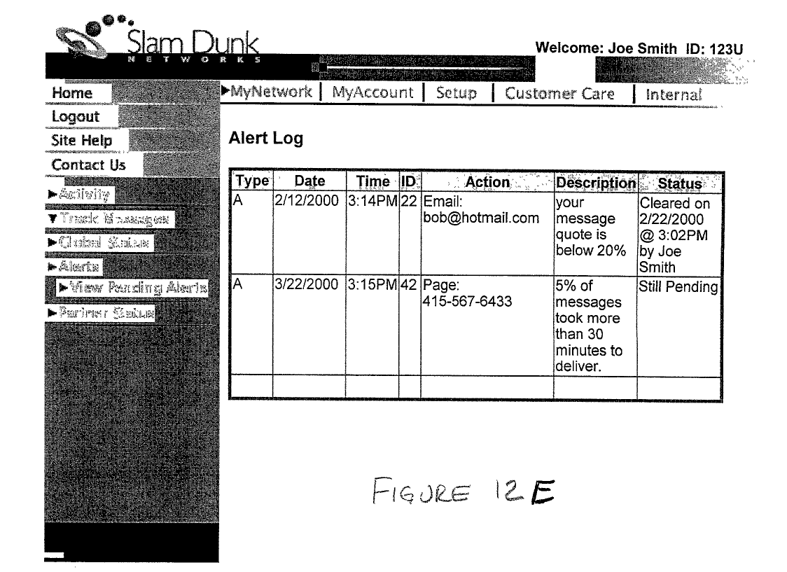

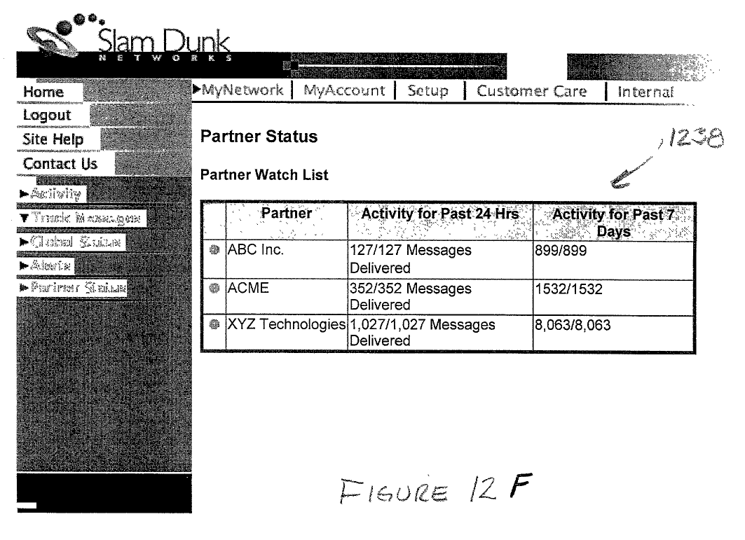

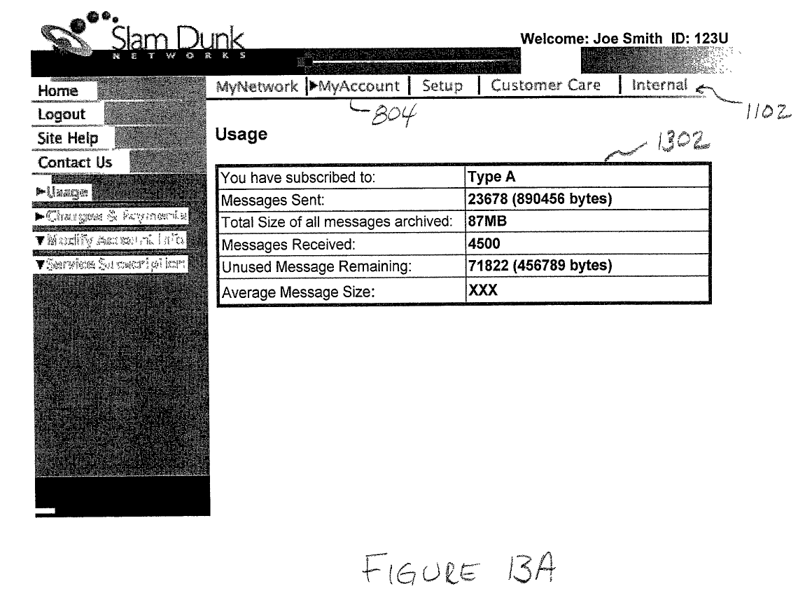

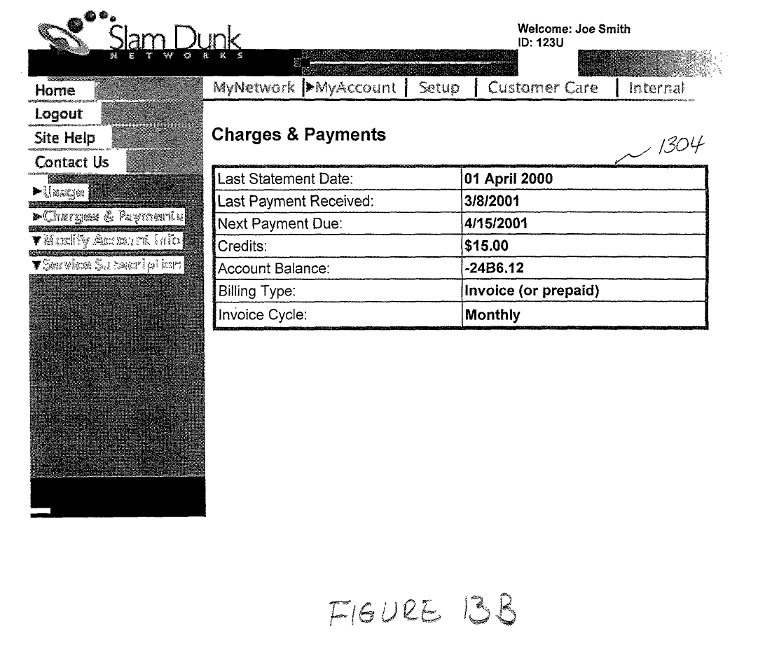

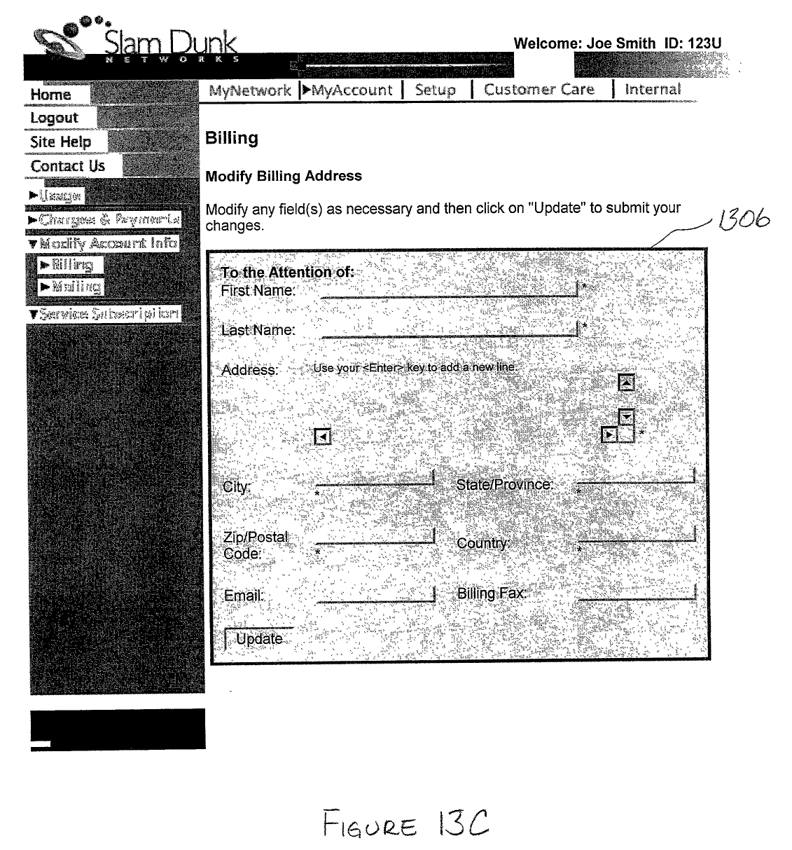

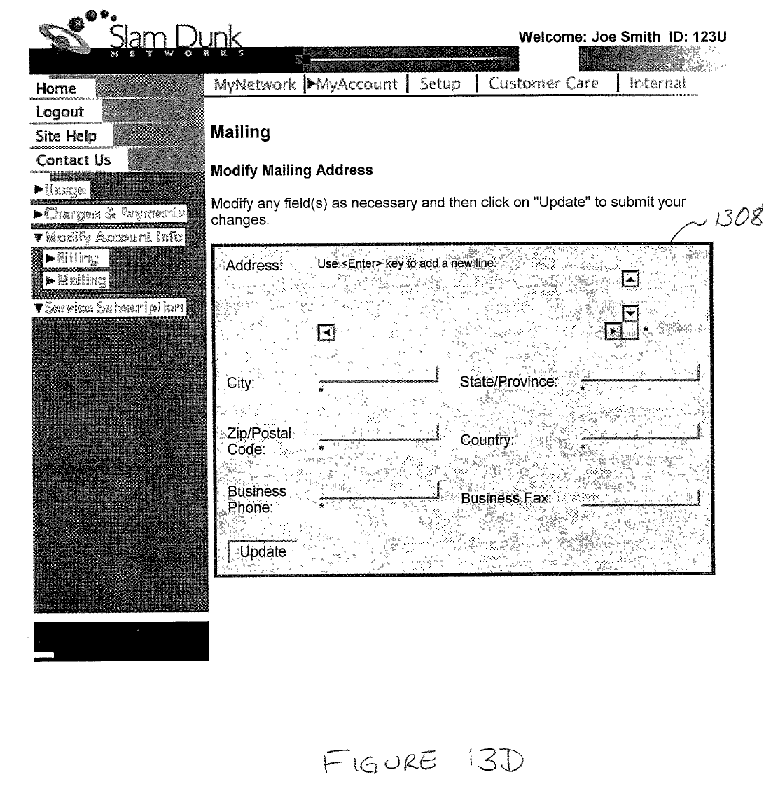

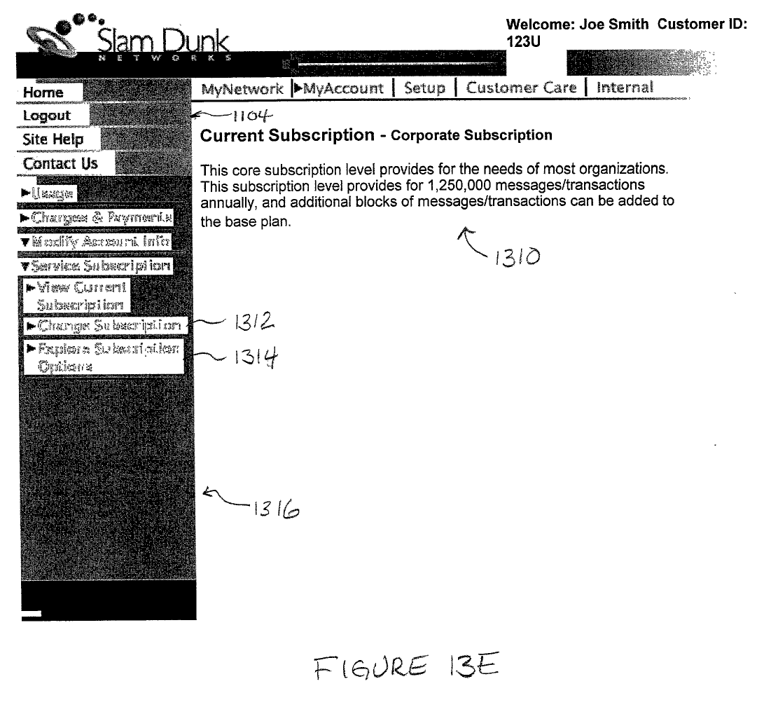

FIGS. 13A-13G illustrate the web page documents that may be displayed when the user selects “MyAccount” button 804 from the horizontal navigation bar 1102. The MyAccount branch provides the user several functions such as viewing the selected service level, the usage of service, details regarding payment and charges incurred as well as the ability to modify account information or service levels.

Referring to FIG. 13A, the user is provided a real-time summary of their account. Specifically, as shown at 1302, account status is shown in tabular form. In the preferred embodiment, the selected level of service is shown together with the number of messages and message size sent to-date, the size of messages stored in the archives, the number of messages received and the number of messages remaining on the account before additional payment is due. Also shown is the average message size.

FIG. 13B illustrates the users charges and payment history. This information is shown in tabular format as shown at 1304. The user may change or update their billing and mailing address using the template forms 1306 and 1308 shown in FIGS. 13C and 13D, respectively.

FIG. 13E illustrates the currently selected service level for the account together with a brief description as shown at 1310. If the user desires to change their service level, the “Change Subscription” button 1312 or the “Explore Subscription Options” button 1314 may be selected from the extended portion 1316 of vertical navigation bar 1104. If the user desires to change the selected service level, as indicated by selecting button 1312, the web page document of FIG. 13F is displayed.

FIG. 13F illustrates the web page for changing the account service level or to add additional message space to the archives. The user may select either service by toggling the appropriate toggle button as shown at 1318. If the user selects the “change” toggle button, dialog box 1320 is displayed. Dialog box 1320 enables the user to select the desired plan using button 1322. When the desired plan is selected, the “Change My Subscription” button 1324 is selected to update the account status information. This change will be reflected in the account summary document (FIG. 13A) the next time the document is accessed.

FIG. 13G may be displayed when the user is unsure of the service level that would be most appropriate for their usage level.

If the user selected the “add more messages” toggle button, dialog box 1326 will be displayed. Dialog box 1326 enables the user to incrementally add messages to the account to compensate for unexpected increases in traffic volume. By selecting the number of incremental messages, the account is updated by selecting the “Add to Subscription” button 1328. This change will also be reflected in the account summary document when next accessed.

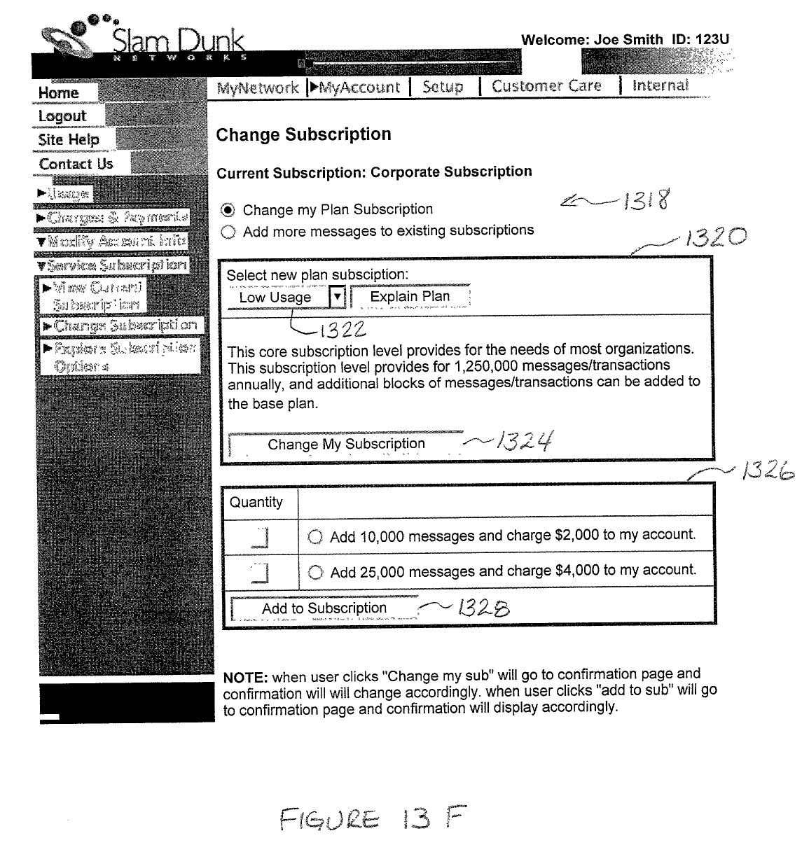

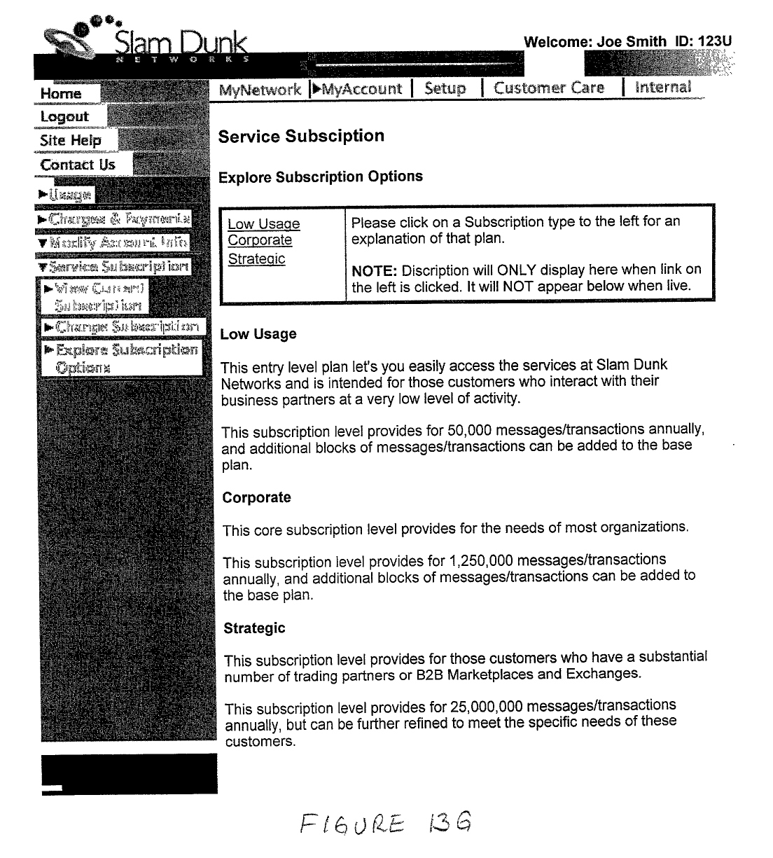

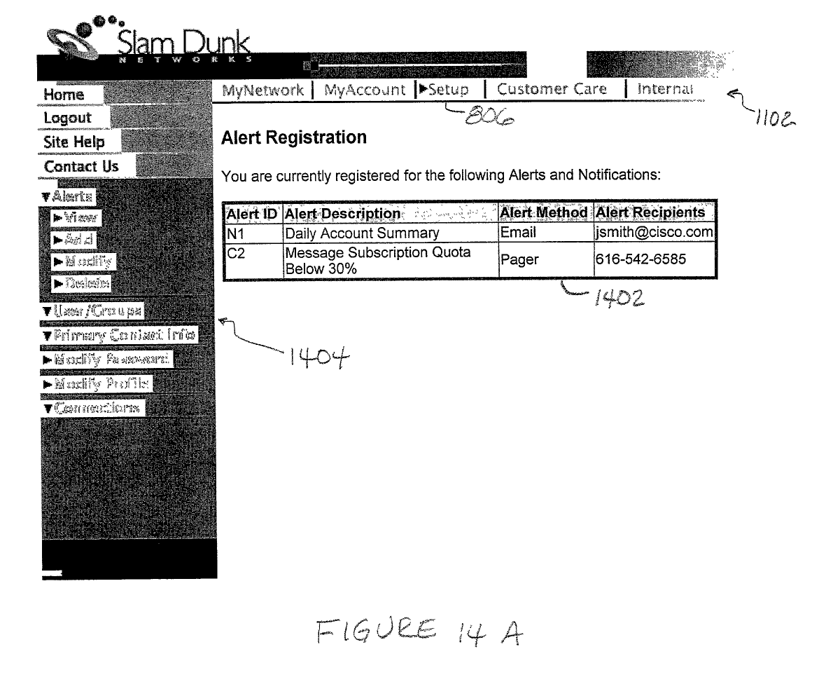

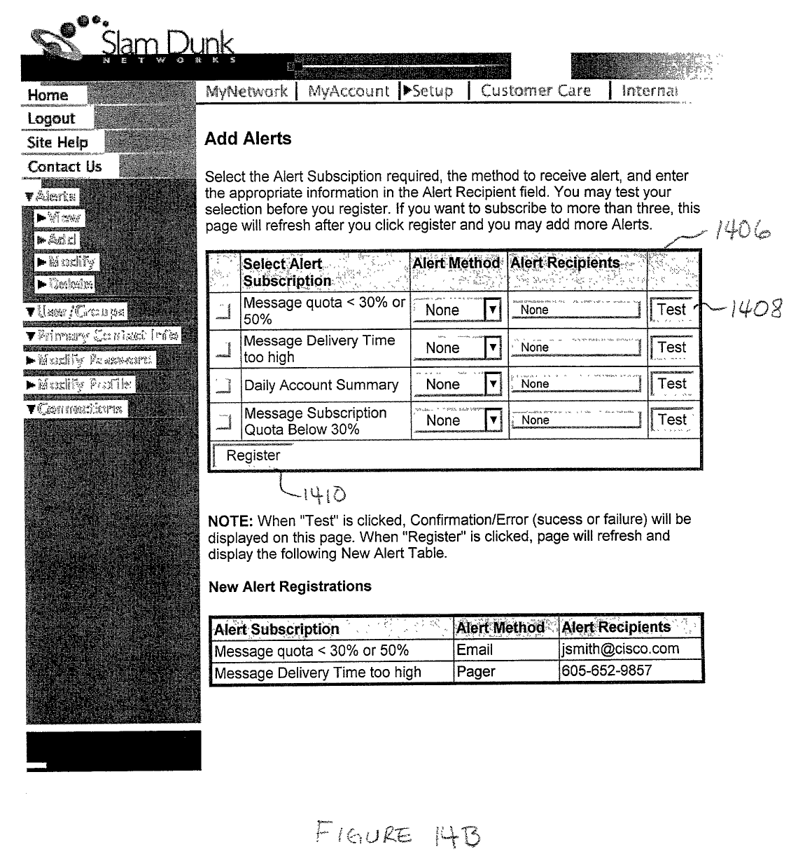

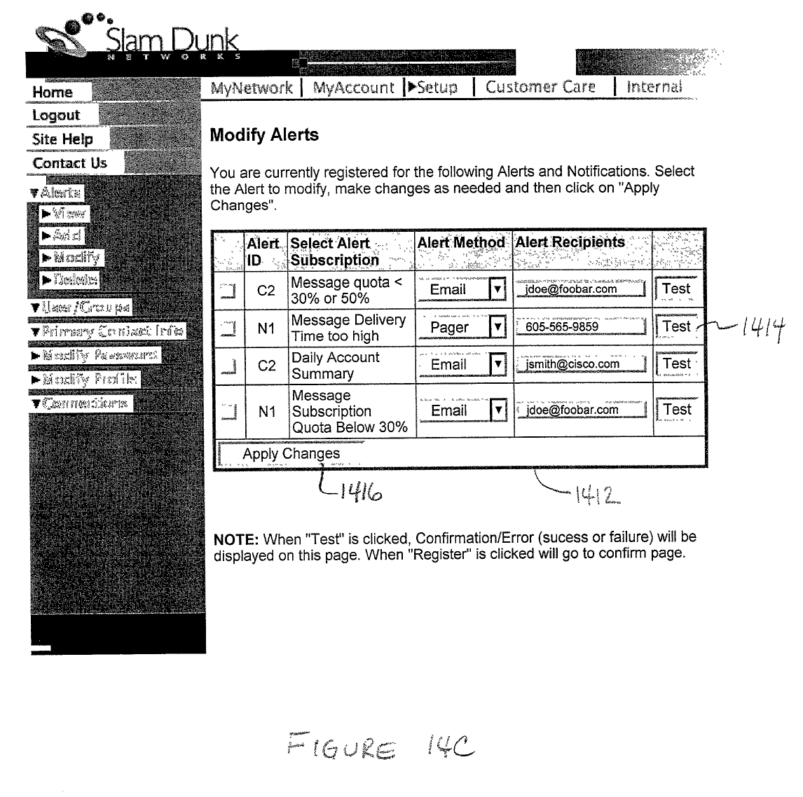

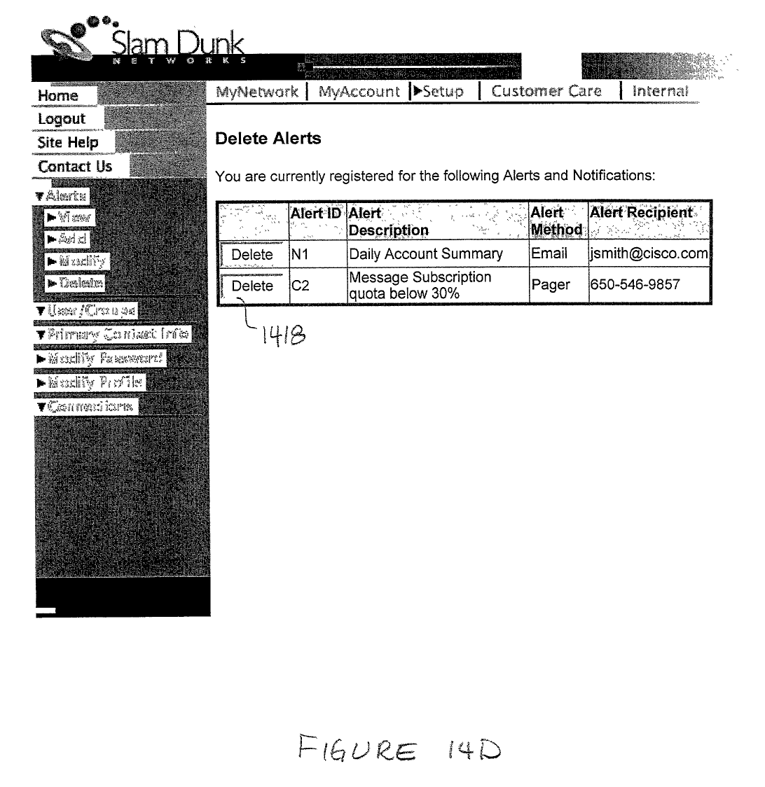

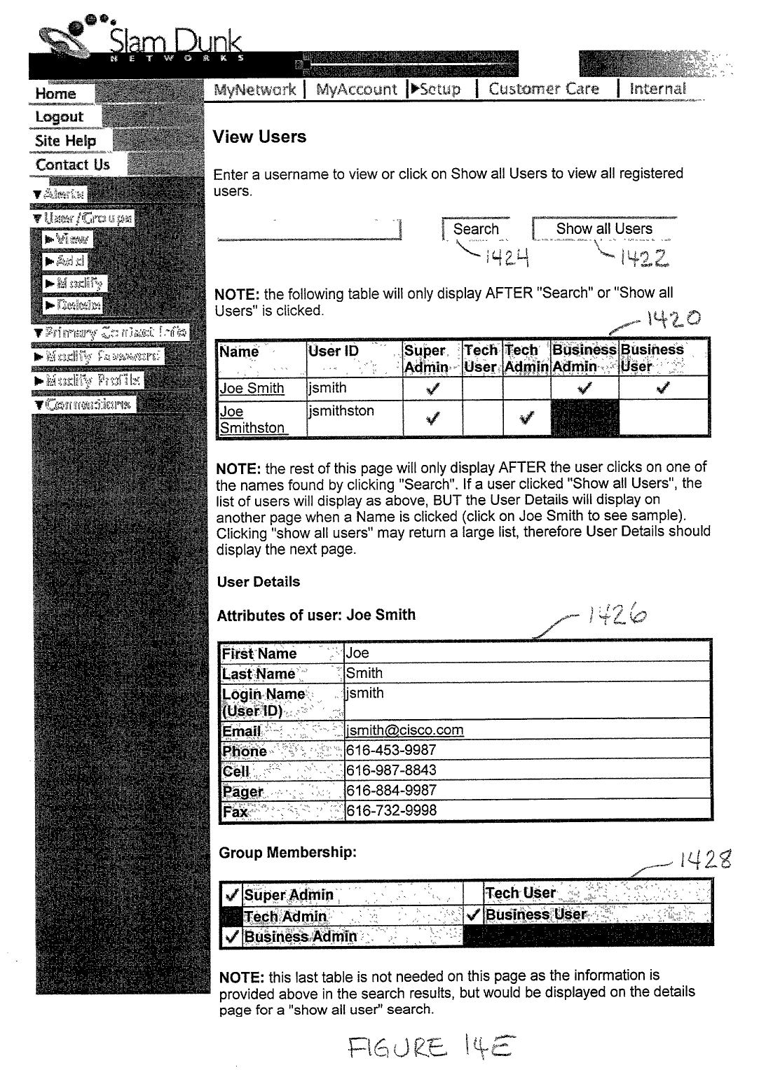

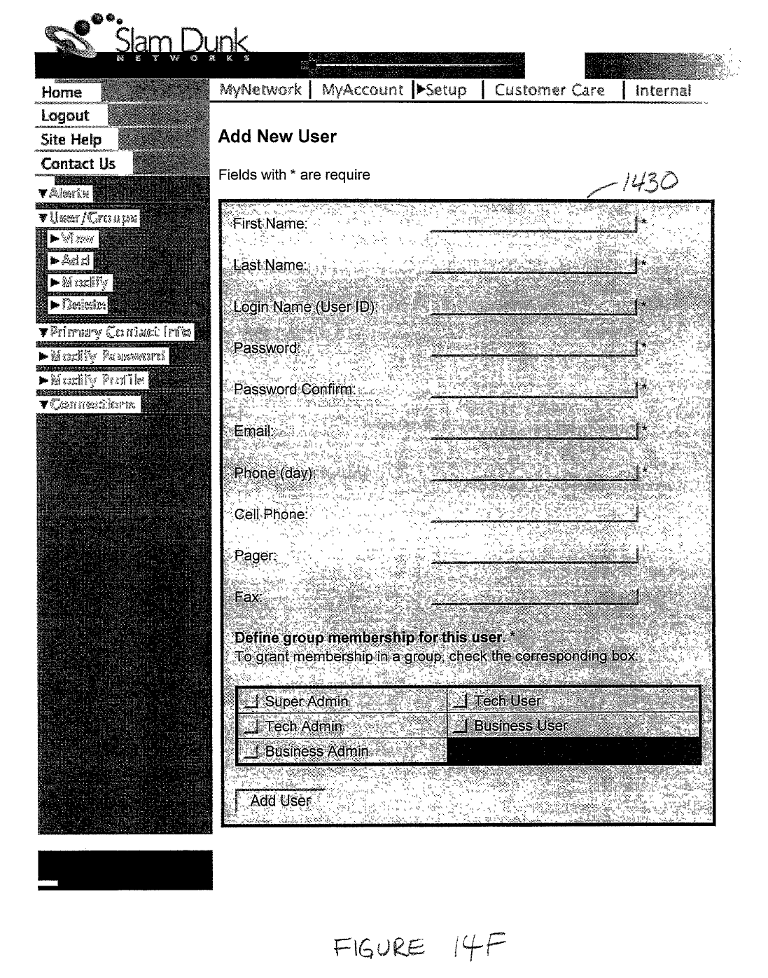

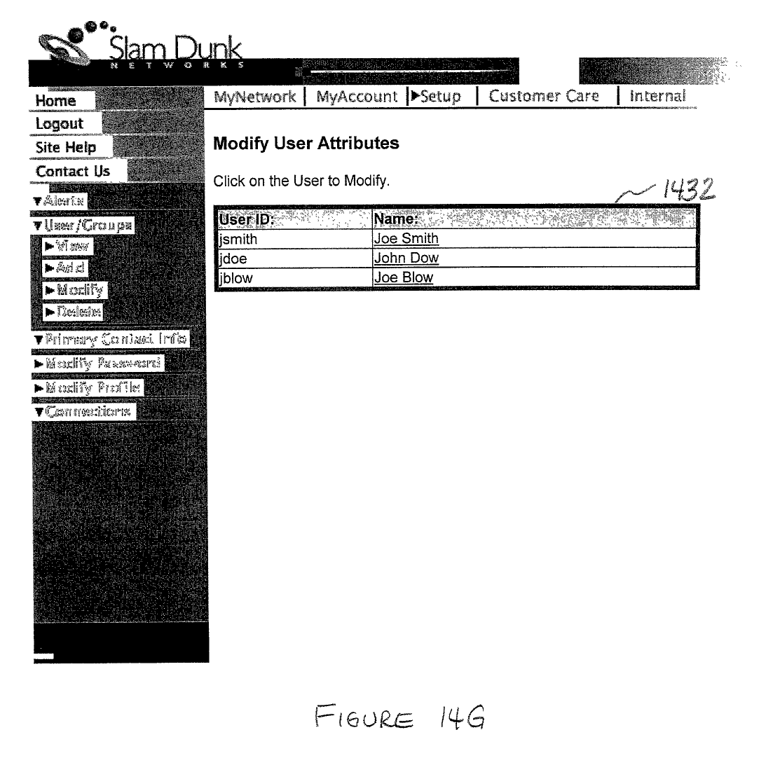

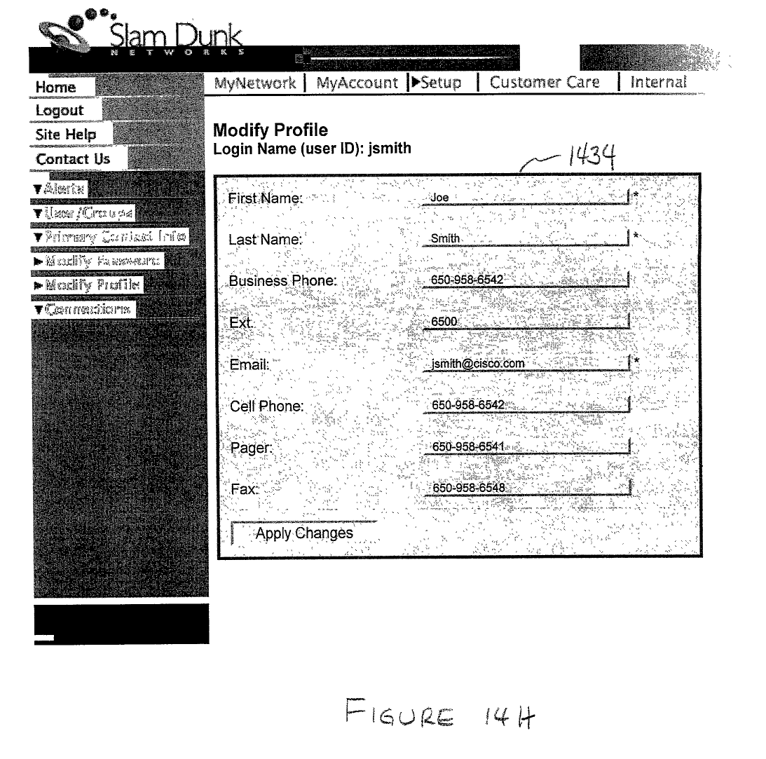

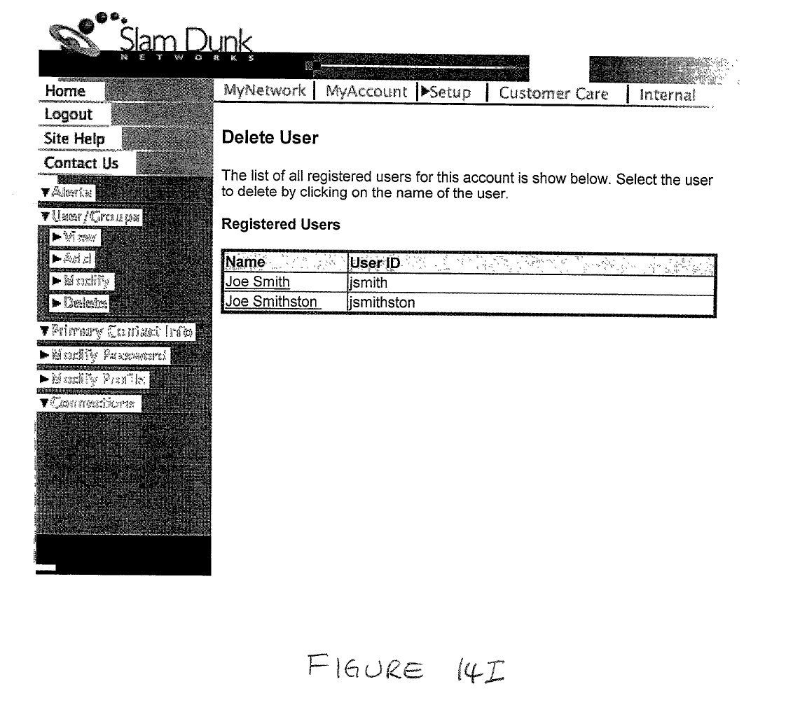

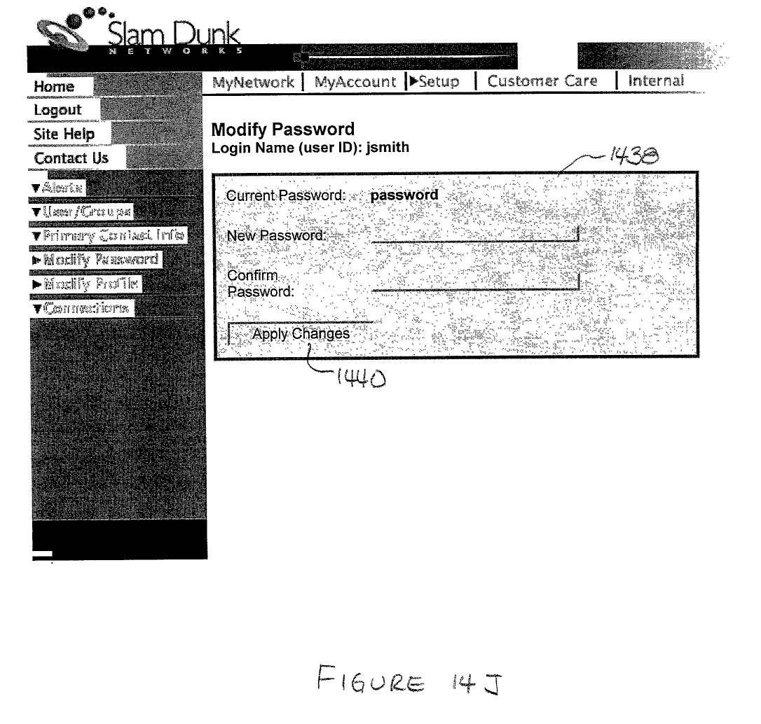

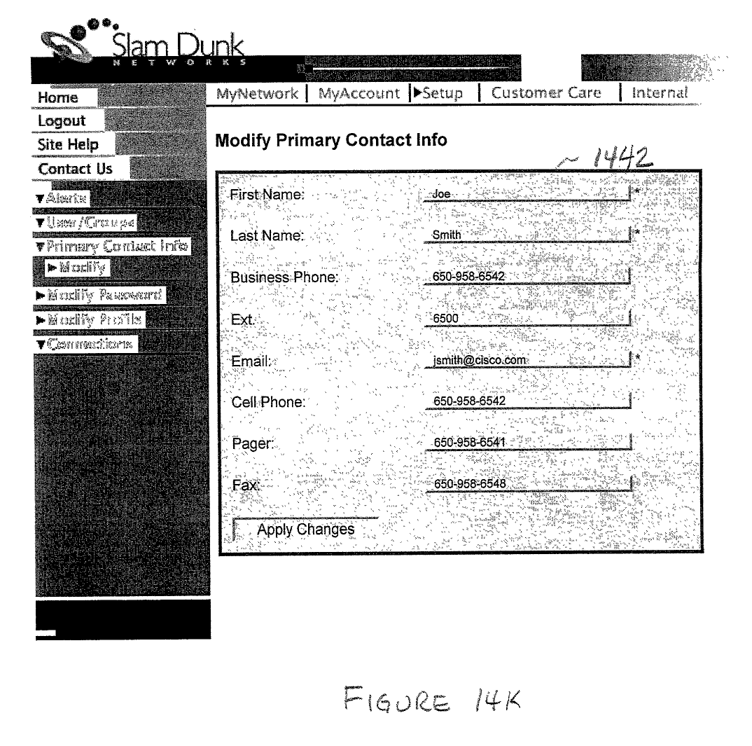

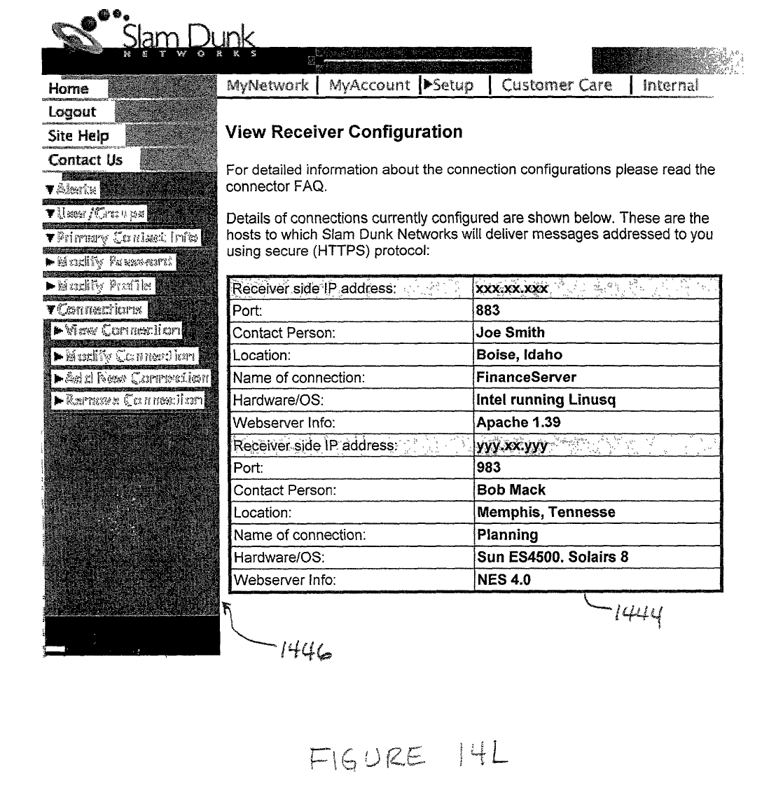

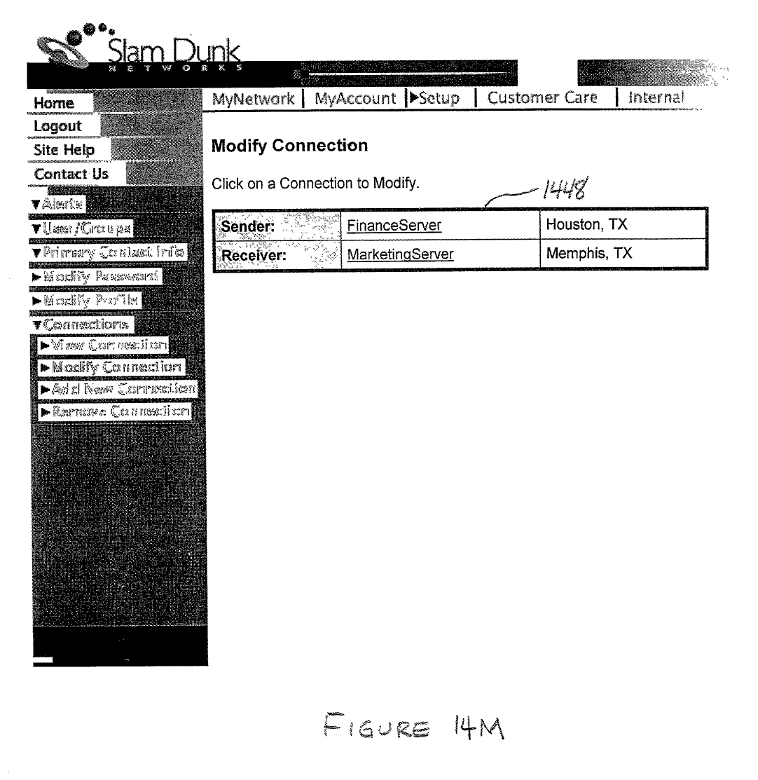

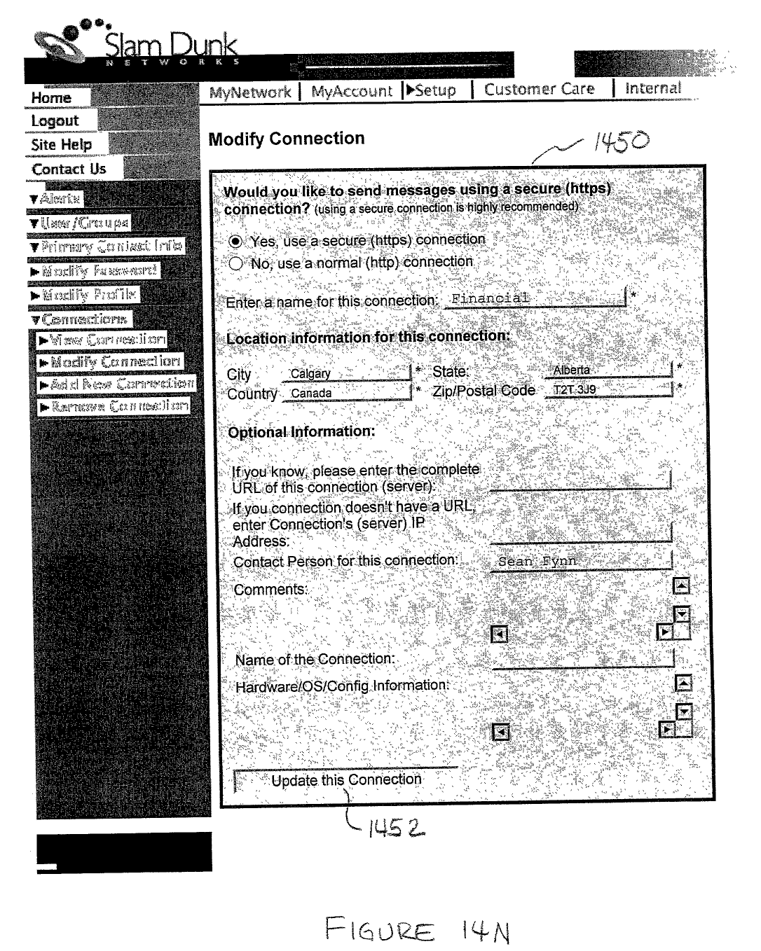

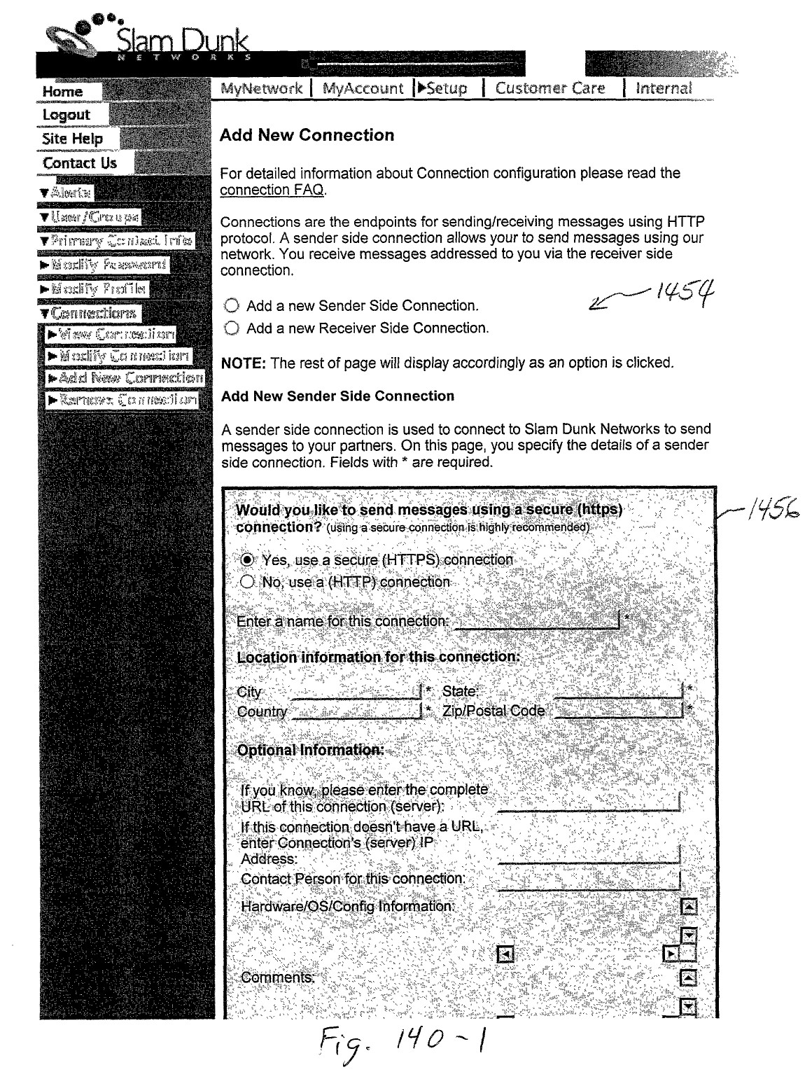

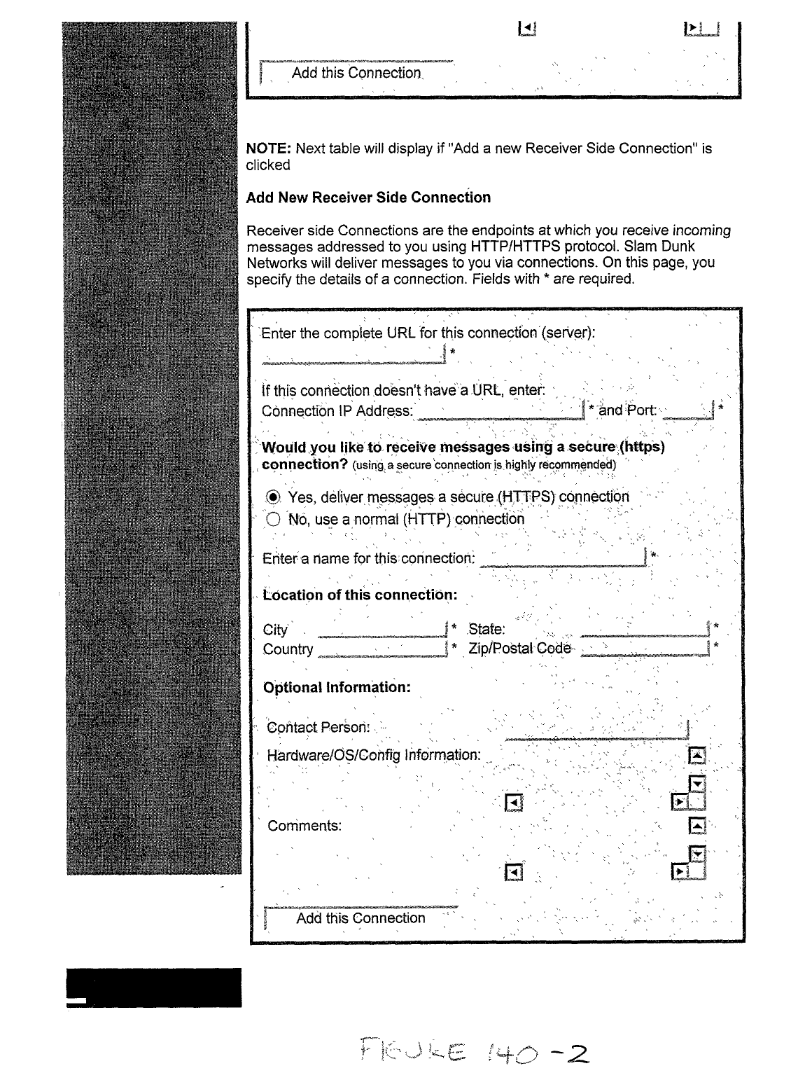

FIGS. 14A-14P illustrate the web page documents that are accessed when the user selects “Setup” button 806 from horizontal navigation bar 1102. The Setup branch provides functions for configuring operation of network 100. Specifically, the user may configure alert and notification levels (FIG. 14A), add or change login information for authorized users (FIG. 14E) and configure connections to networks 101 and 102 (FIG. 14L).

FIG. 14A enables the user to configure alerts conditions that will be monitored by network manager 108. When Setup button 806 is selected a web page is returned showing the current alert registration status in table 1402. This “View” page presents a table 1402 that shows an alert ID, alert description, alert method and the alert recipient in a columnar format. If the alert registration is to be changed, the appropriate button may be selected from vertical navigation bar extension 1404.

If the “Add” button is selected, the “Add Alert” page is returned. Using the toggle buttons in dialog box 1406 the user may customize the alert subscription, the alert method and the alert recipients. Once set up, the user may select the “Test” button 1408 to verify that the alert recipient is promptly notified by the selected alert method. When the alert subscriptions are set up, the user may select the “Register” button 1410 to update the user's alert profile. This information will thereafter be reflected whenever the view page is accessed. Also, if the alert condition is encountered, the appropriate notification is generated and transmitted.

To modify the alert subscription, the “Modify Alerts” page shown in FIG. 14C is returned. Using the toggle buttons in dialog box 1412. The dialog box displays the currently selected alert subscriptions and enable the user to change information. For example, the alert recipient may be changed to reflect employee turnover or changes in responsibilities. Once the changes to dialog box 1412 are completed, the user may select the test buttons 1414 to verify the alert is delivered as intended and then the “Apply Changes” button 1416 is selected to update the user's alert profile.

From time to time it may be necessary to delete one or more of the registered alerts. When the delete button is selected from the vertical navigation extension 1404 (FIG. 14A), the “Delete Alert” page, shown in FIG. 14D is shown. By selecting the “delete” button 1418 the corresponding alert is removed from table 1402 (FIG. 14A) the next time it is displayed. For the user's reference, the contents of table 1402 are displayed together with button 1418.

FIGS. 14E-14K enable an authorized user to change the access levels associated with other users. As shown in FIG. 14E, a table of authorized users 1420 is shown when either button 1424 or 1422 is selected. Once a specific user is identified, a table 1426 is displayed showing the selected user's attributes which may be changed by typing over the existing information. Access control is provided by setting the user's group membership as shown in dialog box 1428. FIG. 14F enables a user with administrative authorization to add additional user by entering the appropriate data in to dialog box 1430. Similarly, user attributes may be modified by selecting a user from a displayed list in table 1432 shown in FIG. 14G. The selected user's attributes are displayed in dialog box 1434 of FIG. 14H so that they may be readily modified. At other times, a specific user may be removed from the list of authorized users by selecting the user from the list presented in dialog box 1436 of FIG. 141. A user may modify their password by selecting the corresponding button from vertical navigation extension 1404 (FIG. 14A), entering the new password into dialog box 1438 shown in FIG. 14J and selecting the “Apply Changes” button 1440. Finally, an authorized user may modify the primary contact information by entering the new information into dialog box 1442 as shown in FIG. 14K.

FIGS. 14L-14P enable an authorized user to view and configure the information that describes connection configuration. FIG. 14L shows a table 1444 that lists the current connection configuration for the destination connectors. When the connection configuration changes, the user may select the “Modify” option from the vertical navigation bar extension 1446. FIG. 14M illustrates a selection dialog box 1448 that lists the connectors associated with the user. Once selected, a “Modify Connection” dialog box 1450 as shown in FIG. 14N for the selected connection. Dialog box 1450 requests certain information from the administrative user which is transferred to the user's profile maintained by network controller 108 (FIG. 1) by selecting the “Update this Connection” button 1452. In a similar manner, the administrative user may also add additional connections using the toggle buttons 1454 and “Add New Connection” dialog button 1456 as shown in FIG. 140. Finally, the administrative user may remove a connection from the network by listing the connections and then selecting the “Remove Connection” button 1458 from the display box 1460 as shown in FIG. 14P.

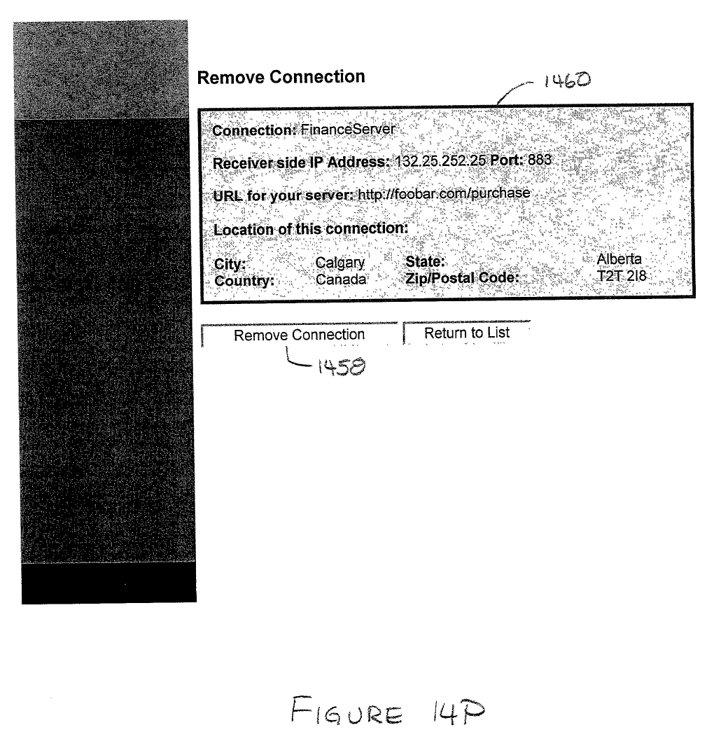

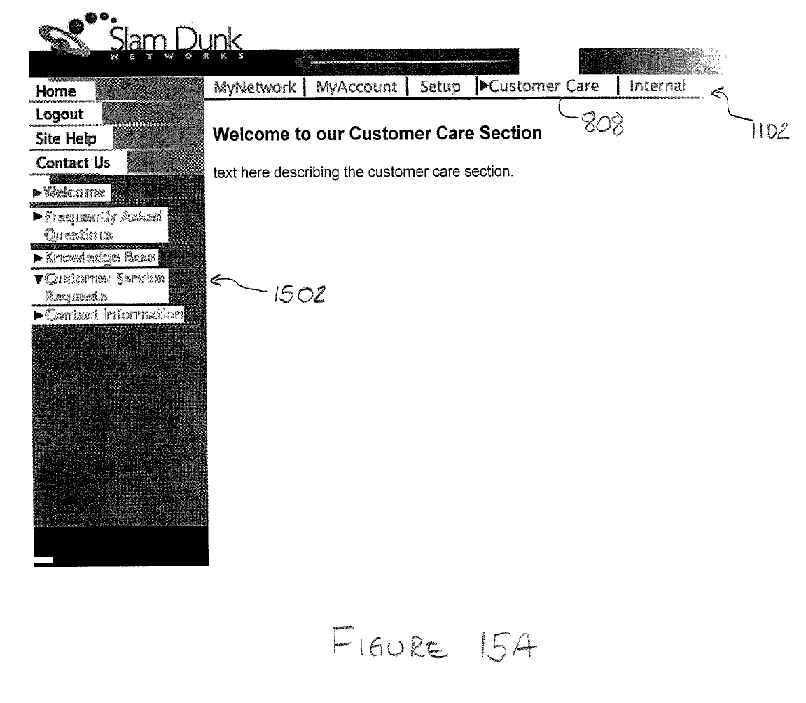

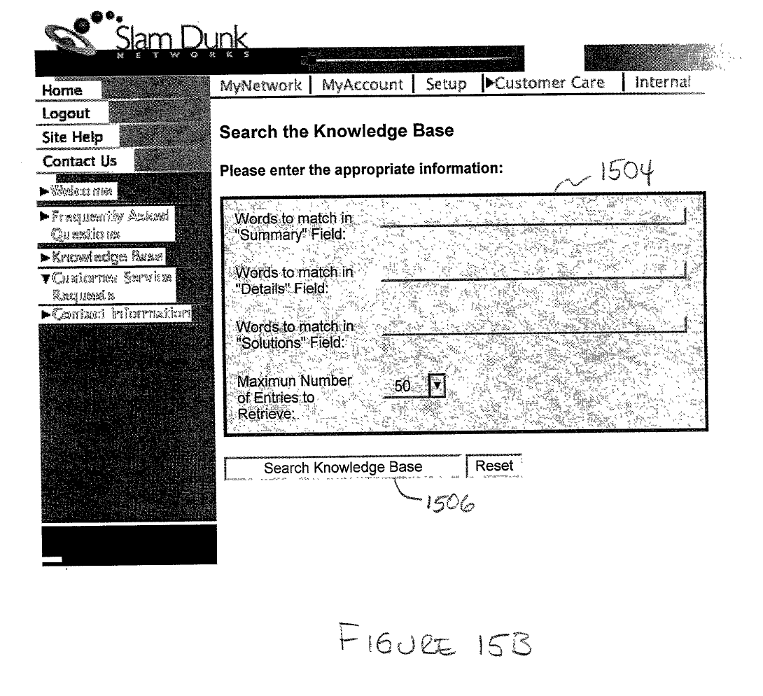

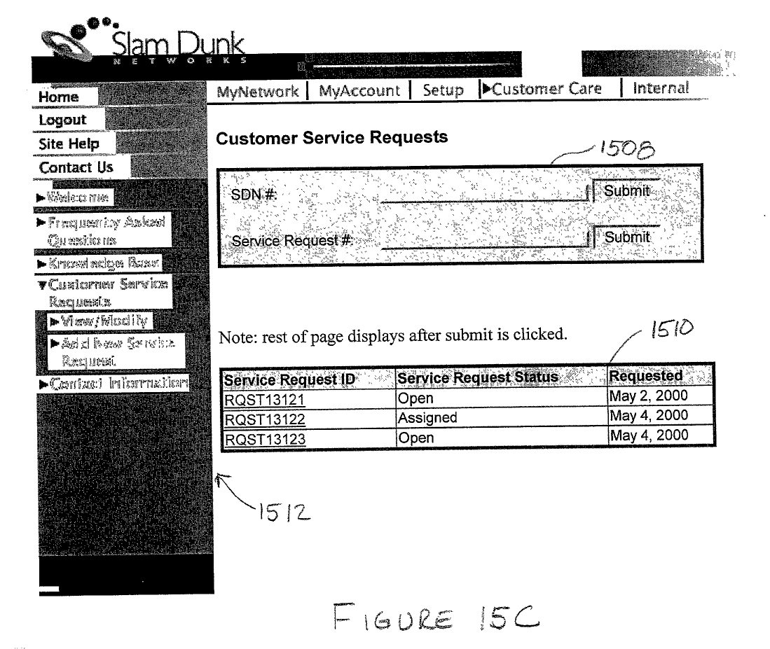

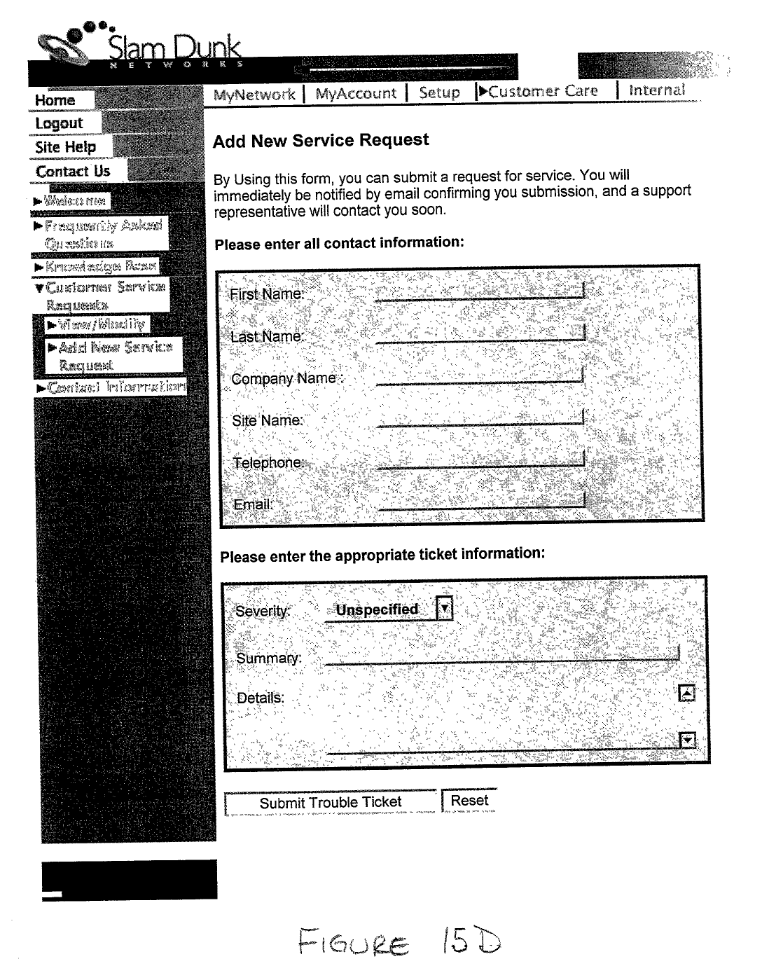

FIGS. 15A-15D illustrate the web page documents that are accessed when the user requires general help or desires to send a request for customer service. These documents are accessible when the employee selects “Customer Care” button 808 from horizontal navigation bar 1102. From this “Welcome” splash page, the user may access a list of frequently asked questions, a Knowledge database (FIG. 15B) and a Customer Service Request (FIG. 15C). These functions are accessed by selecting the appropriate button from the vertical navigation bar extension 1502.

FIG. 15B illustrates the dialog box 1504 provided for entering a search request. This dialog box enables the search to be focused on specific fields. Selecting the “Search Knowledge Base” button 1506 initiates the search. If a customer service request is selected, dialog box 1508 is displayed as shown in FIG. 15C. From this dialog box the user can track the status of the pending service requests as indicated by list 1510. Selecting the “Add New Service Request” button from the vertical navigation bar extension 1514 causes the document shown in FIG. 15D. FIG. 15D illustrates the trouble ticket 1516 that a user can fill out and submit to the network administrator for resolution. Once submitted the user can track the status from dialog box 1508.

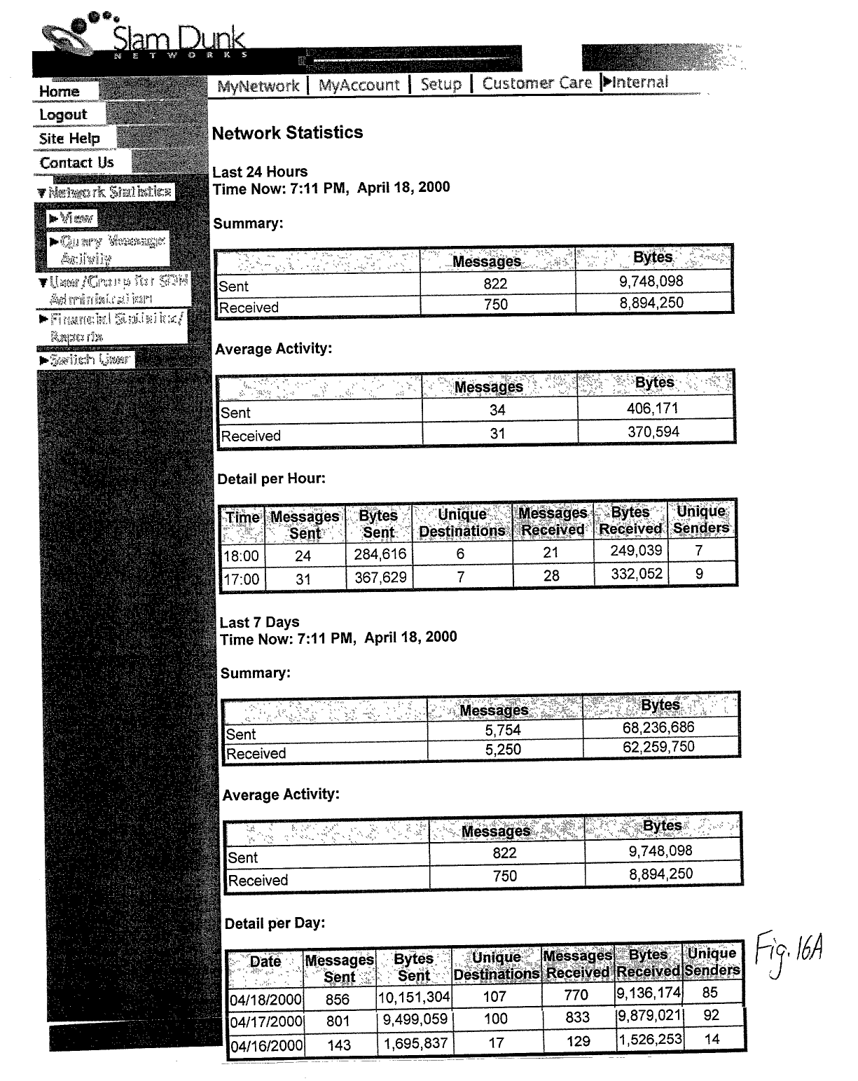

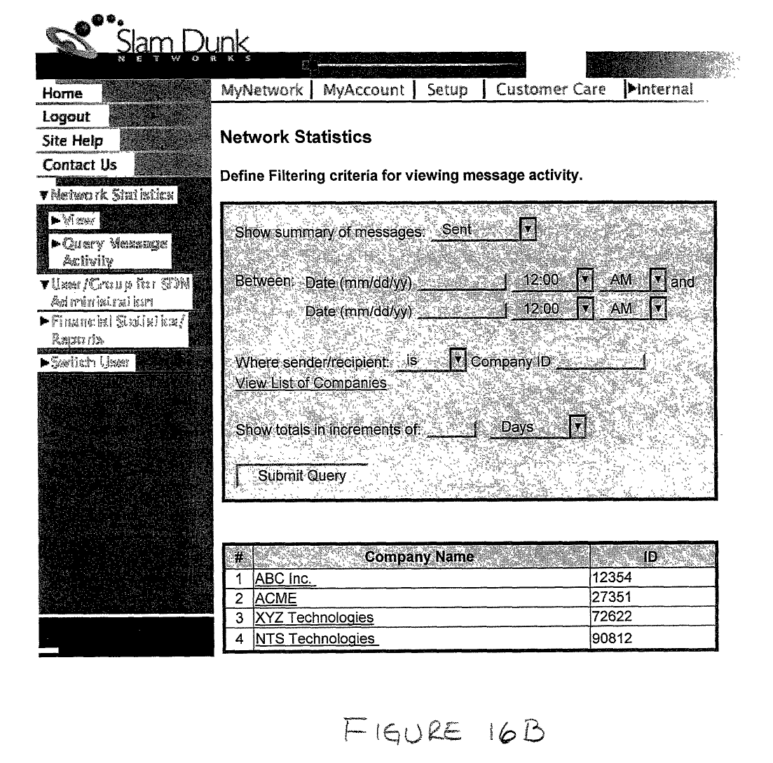

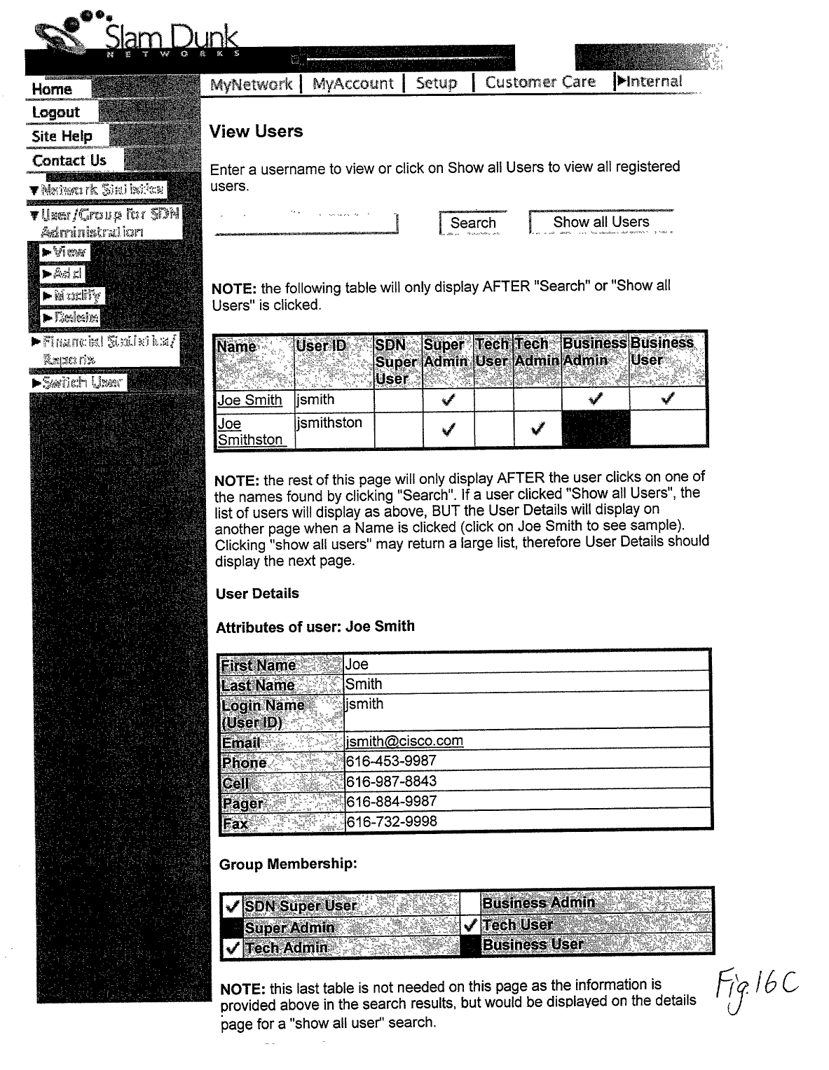

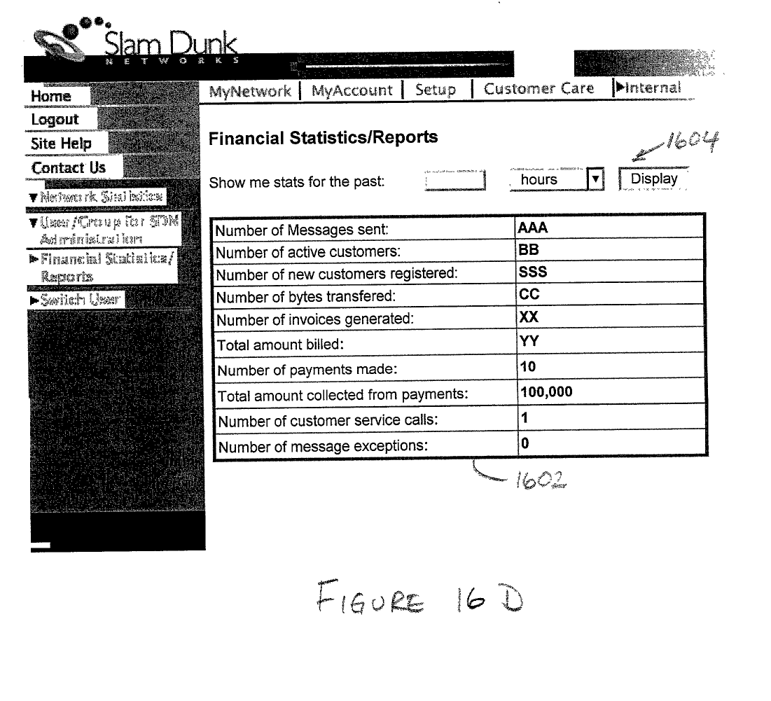

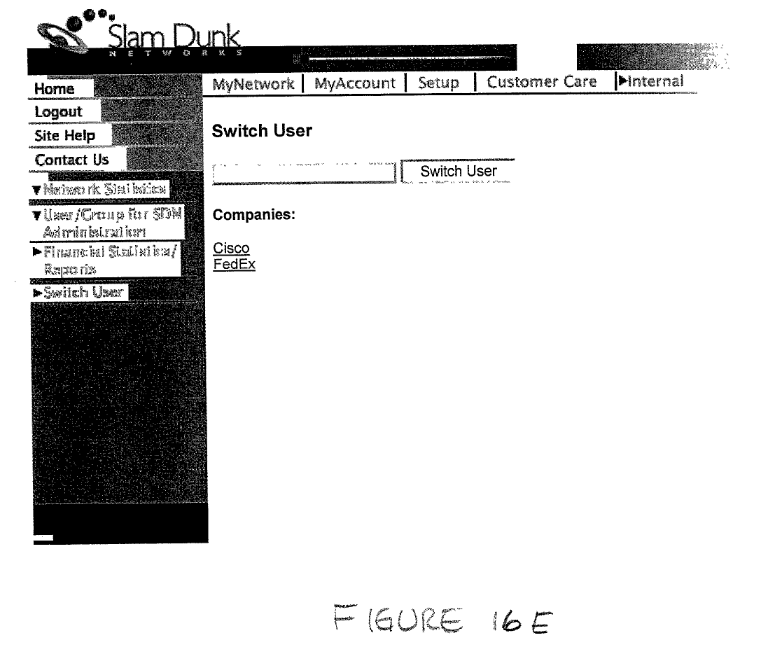

Referring now to FIGS. 16A-16E, web page documents are illustrated that are accessed by employees of the assignee of the present invention, Slam Dunk Networks to monitor and respond to problems in a timely fashion. These documents are accessible when the employee selects “Internal” button 808 from horizontal navigation bar 1102. The Internal branch provides functions for configuring operation of network 100. Specifically, the employee may monitor network status (FIG. 16A), define a filter criteria to view message activity level (FIG. 16B), obtain a listing of users (FIG. 16C), generate Financial reports (FIG. 16D) and select a specific user to monitor (FIG. 16E). The information described in these drawings of FIGS. 16A-16C is similar to that described above with respect to information presented to the user (see, for example FIG. 12A) and will not be explained further. One skilled in the art will understand that the information provided at this level may include information in addition to that shown in the figure. For example, the network communication backbone status may be monitored in real-time by employees.

With respect to FIG. 16D, the displayed document shows the financial status associated with a particular user in Table 1602. This information can be filtered by selecting the appropriate criteria as indicated at 1604. Information from other users, can be obtained by switching to that particular user on the “Switch User” document as shown in FIG. 16E.

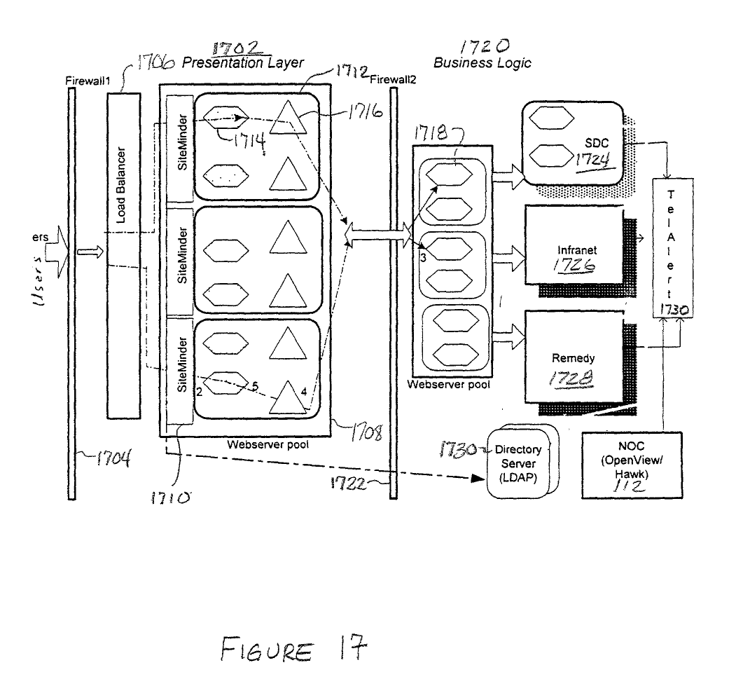

Referring now to FIG. 17, one embodiment of the configuration of portal 116 is illustrated. Portal 116 includes a presentation logic layer 1702 that is maintained behind a firewall 1704. Users access presentation logic layer 1702 through firewall 1704. When a user directs a request to access the presentation logic layer, a load balancer 1706 directs that request to one of a plurality of servers maintained in webserver pool 1708. Each server in the webserver pool 1708 includes an application 1710 that provides security functions and centralized management across the web servers, application servers and operating systems. In one preferred embodiment, the security application is an application server agent marketed under the SiteMinder trademark by Netegrity, Inc. of Waltham, Mass.

When a user submits a request at portal 116, the load balancer 1706 directs the user's request to an available webserver. Once the user is identified, access is provided to a webserver machine 1712 running proxy servlets 1714 in the presentation logic layer 1702. Proxy servlet 1714 accepts the user's request and forwards it to the appropriate facade object 1716. Facade object 1716 builds an XML message and sends it to a servlet, such as servlet 1718, in the business logic layer 1720. A servlet in the business logic layer 1720 receives the XML message through a second firewall 1722 and reads the XML message. The servlet then fetches the requested information from the appropriate subsystem, e.g., subsystem 1724, 1726 or 1728. Subsystem 1724 is a server or other computer systems running various components of network 100 such as databases, servlets or webservers. Subsystems 1726 and 1728 are web servers that execute third party applications such as Remedy, OpenView and InfraNet, by way of example. Once the servlet has fetched the information, the servlet then synthesizes an XML message and sends it back to the presentation logic layer 1702. At the presentation logic layer 1702, the proxy servlet 1716 applies the appropriate XSL style sheet to the received XML message and sends the generated output to the user. The user may access directory server 1730 to conduct searches which utilizes LDAP (Lightweight Directory Access Protocol) as the protocol for accessing directory services.

Portal 116 uses the archived messages and the open XML API provides a unique opportunity for accessing the data in the billing database and archive 110 (FIG. 1). Thus, the XML format defines a flexible manner where data obtained from the portal is readily provided to applications. This open API provides a user who is authorized to access the archive or the billing database may configure an application program to enter portal 116 and perform a desired function. This function may interrogate the archive to generate a report specifying, for example, the sales volume of the user's products, customer feedback or simply determine the number of messages being traded with each of the user's trading partners. Other functions may be readily implemented with the open XML API.

One skilled in the art of Internet and server programming will appreciate that subsystems 1726, 1728 and NOC 112 may be commercially available software products. By way of example, Remedy (Subsystem 1728) is a client-server software package, available from Remedy Corp. in Mountain View, Calif., that implements help desk function for problem management and resolution, asset inventory, change tasking, and reporting capabilities. OpenView (NOC 112) manages network infrastructure, allocate resources, and measure performance against customer defined service level agreements available from Hewlett-Packard Company of Palo Alto, Calif.. Intranet (subsystem 1726) is an is a real-time billing solution for data telecommunication services available from Portal Software, Inc. of Cupertino, Calif. Although specific software is specified herein it is to be understood that other software may be used to provide similar functions and features.

FIG. 17 further includes a logic module 1730 operating on a server computer for generating alerts so that network management staff may be promptly notified of any problems or conditions on the network. In one preferred embodiment, logic module 1730 is a commercial product sold under the TelAlert trademark by Telamon, Inc. of Oakland, Calif. The logic module passes alerts generated by subsystems 1724, 1726 and 1728 or by NOC 112 using pagers, telephone, email or signboards. Client modules are installed at each computer in network 100 and the clients communicate with the logic module 1730 which processes all alerts centrally.

Portal 116 further provides a means for distributing XML messages from subsystem 1724 to the other components of network 100. More specifically, when the software code executed by a components is to be changed, the present invention allows this code to be wrapped in an XML message and distributed to each connector 104, route point processor 106 and archivel 110 (see FIG. 1). A further advantage is that the changed software need not be distributed to all components at one time but rather may be distributed over time. This enables network 100 to continuously operate even while software at a portion of the components is being changed. This feature is provided by including in the header associated with each message a version number of the software the particular component is using. Thus, if the source connector is using software code with an “A” revision, both the route point processors and the destination connector will check the version number and understand how to interpret the XML message even if they are operating under a subsequent version of the software.

While certain exemplary preferred embodiments have been described and shown in the accompanying drawings, it is to be understood that such embodiments are merely illustrative of and not restrictive on the broad invention. Further, it is to be understood that this invention shall not be limited to the specific construction and arrangements shown and described since various modifications or changes may occur to those of ordinary skill in the art without departing from the spirit and scope of the invention as claimed.

What is claimed is:

1. In a networked computer system for transmitting messages from a source to a destination, an apparatus for managing the delivery of messages to said destination, said apparatus comprising:
means for tracking and guaranteeing the delivery of said messages to said destination;
means for monitoring said tracking and guaranteeing means from a single web site;
means for archiving said messages.

2. The apparatus as claimed in claim 1 further comprising a database associated with said monitoring means for counting the number of messages delivered during a selected time period.

3. The apparatus as claimed in claim 1 wherein said monitoring means comprises an XML application program interface.

4. The apparatus as claimed in claim 3 further comprising means for conducting searches.

5. The apparatus as claimed in claim 3 wherein said monitoring means comprises a portal accessible via the Internet.

6. The apparatus as claimed in claim 3 wherein said monitoring means comprises:
a first server for receiving requests from a user via the Internet, said first server adapted to generate an XML message in response to said request;
a second server adapted to receive said XML message and to perform a function responsive to said XML message; and
means coupled to said second server for communicating the results of said function to said user.

7. The apparatus as claimed in claim 6 wherein said monitoring means further comprises means for distributing XML messages to said delivery means via the Internet, said XML messages containing operating instructions for changing the operation of said delivery means.

8. The apparatus as claimed in claim 6 further comprising a database associated with said monitoring means for counting the number of messages delivered during a selected time period.

9. The apparatus as claimed in claim 6 further comprising means, associated with said monitoring means, for recovering at least one of said archived messages

10. The apparatus as claimed in claim 1 wherein said monitoring means comprises an XML application program interface (API) further comprising:
means for receiving a request for a function;
means for building an XML message;
means for interpreting said XML message, said interpreting means adapted to perform the requested function and returning an XML message to said building means; and
means for applying a XSL style sheet to the received XML message and sending the generated output to the user.

11. The apparatus as claimed in claim 10 further comprising means for conducting searches.

12. The apparatus as claimed in claim 10 wherein said receiving means comprises a portal accessible via the Internet.

13. The apparatus as claimed in claim 10 wherein said monitoring means comprises:
a first server for receiving requests from a user via the Internet, said first server adapted to generate an XML message in response to said request;
a second server adapted to receive said XML message and to perform a function responsive to said XML message; and
means coupled to said second server for communicating the results of said function to said user.

14. The apparatus as claimed in claim 13 wherein said monitoring means further comprises means for distributing XML messages to said delivery means via the Internet, said XML messages containing operating instructions for changing the operation of said delivery means.

15. The apparatus as claimed in claim 10 further comprising a database associated with said monitoring means for counting the number of messages delivered during a selected time period.

16. A computer implemented method for exchanging information between trading partners where a source connector generates a message containing the information, said messages transmitted as a primary message to a destination connector over a first communication backbone and as a secondary message to said destination connector over a second communication backbone, said method comprising:
monitoring the transmission of said primary and secondary messages;
receiving a request from said trading partners via a web site, said request relating to the transmission of said message;
generating a response to said request, said response generated by querying at least one database having information relating to said primary and secondary messages; and
transferring said response to said trading partner.

17. The method as claimed in claim 16 further comprising:
counting the number of messages delivered during a selected time period; and
transferring an invoice to the trading partner generating said message.

18. The method as claimed in claim 16 further comprising conducting searches for information responsive to said request stored in said database.

19. The method as claimed in claim 16 further comprising:
receiving requests from a user via the Internet;
generating an XML message in response to said request;
receiving said XML message at a server computer adapted to access information stored in said database;
performing a function responsive to said XML message; and
communicating the results of said function to said user.

20. The method as claimed in claim 19 wherein said receiving and communicating steps utilize specific route points and a distributed communication network.

21. The method as claimed in claim 20 further comprising the step of counting the number of messages delivered during a selected time period.

22. The method as claimed in claim 19 further comprising recovering at least one of said archived messages in response to said request.

23. A computer implemented method for exchanging information between trading partners in a distributed computer networking system in which each trading partner has a connector for initiating the transmission of a message along two separate communication backbones, said method comprising the steps of:
generating a message header for each message for which a charge is to be imposed; and
associating with said message header an indication of the time of delivery to the trading partner at the destination.

24. The method as claimed in claim 23 wherein said associating step includes the step of transmitting each message header to a billing database.

25. The method as claimed in claim 23 wherein said generating step includes the step of determining statistical information regarding transmission latency.

26. The method as claimed in claim 25 further comprising the step of providing said statistical information to a user through an Internet portal.

27. The method as claimed in claim 26 further comprising the steps of:
submitting a request through said portal;
identifying the user associated with said request;
accepting said request at a webserver, said webserver adapted to building an XML message interpreting said request;
fetching information responsive to said XML message;
preparing a responsive XML message, said responsive XML message including said responsive information;
interpreting said responsive XML message;
sending said responsive information to the user associated with said request.

28. The method as claimed in claim 23 wherein said associating step includes the steps of:
transmitting each message header to a billing database, said message header including a sequence number; and
locating messages associated with a sequence number missing from said billing database;
deducting a charge from an account associated with the trading partner generating said message, said charge based on a user profile associated with said billing database.

29. The method as claimed in claim 28 further comprising the steps of:
configuring alerts;
monitoring the transmission of said messages;
generating an alert when a configured alert condition is detected.

30. The method as claimed in claim 23 wherein said generating step includes the step of notifying an alert recipient.
